(19) United States
(12) Patent Application Publication
(10) Pub. No.: US 2015/0288266 A1
(43) Pub. Date: Oct. 8, 2015

(54) AXIAL SWITCHED RELUCTANCE MOTOR INCLUDING MULTIPLE STATOR POLE SETS

(71) Applicants: Kenneth A. DeGrave, Wilson, MI (US); William L McMillan, Midland, TX (US)

(72) Inventors: Kenneth A. DeGrave, Wilson, MI (US); William L McMillan, Midland, TX (US)

(21) Appl. No.: 14/145,923

(22) Filed: Dec. 31, 2013

Related U.S. Application Data
(60) Provisional application No. 61/747,558, filed on Dec. 31, 2012.

(51) Int. Cl. H02K 19/10; H02K 15/02; H02K 1/24

(52) U.S. Cl. CPC H02K 19/103; H02K 1/246; H02K 15/022

(57) ABSTRACT

An axial switched reluctance motor includes a rotor configured to rotate about an axis, wherein the rotor includes a plurality of rotor poles. The switched reluctance motor also include a stator situated about the axis, wherein the stator includes a plurality of stator pole sets. Each stator pole of a stator pole set may be adjacent another stator pole of that stator pole set. Each stator pole within a stator pole set may exhibit the same phase, thus providing a short flux path.

### CROSS REFERENCE TO RELATED PATENT APPLICATION

This non-provisional patent application claims priority to provisional patent application 61/747,558 filed on Dec. 31, 2012 which is entitled “Switched Reluctance Motor”, the disclosure of which is incorporated herein by reference in its entirety.

### BACKGROUND

The disclosures herein relate generally to electronically commutated switched reluctance motors and more particularly to electronically commutated switched reluctance motors that exhibit an axial configuration.

### BRIEF SUMMARY

In one embodiment, an axial switched reluctance motor is disclosed. The switched reluctance motor includes a stator including a plurality of stator poles, the stator poles being situated in a first plane and oriented about a central axis. The rotor is configured to rotate about the central axis in a second plane axially spaced apart from the first plane. Thee stator includes a plurality of stator pole sets, each stator pole set including multiple stator poles that are adjacent one another, each stator pole of a stator pole set exhibiting the same phase.

In one embodiment, each stator pole set of the motor includes a pair of stator poles, the pair of stator poles of each stator pole set exhibiting the same phase which is different from the phase of other stator pole sets of the stator. In one embodiment, the stator includes a back iron assembly that is laminated. In one embodiment, the stator poles of the stator poles sets are laminated. In one embodiment, the rotor includes a back iron assembly that is laminated. In one embodiment, the rotor poles of the rotor are laminated.

In yet another embodiment, a method of fabricating an axial switched reluctance motor is disclosed that includes providing a stator including a plurality of stator poles, the stator poles being situated in a first plane and oriented about a central axis. The method includes providing a rotor configured to rotate about the central axis in a second plane axially spaced apart from the first plane. The method also includes configuring the stator with a plurality of stator pole sets, each stator pole set including multiple stator poles that are adjacent one another, each stator pole of a stator pole set exhibiting the same phase.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a perspective view of an axial switched reluctance motor.

FIG. 2A is a face view of a laminated rotor.

FIG. 2B is a side view of a laminated rotor.

FIG. 2C is a face view of a laminated member.

FIG. 2D is a side view of a laminated member.

FIG. 3A is a face view of a laminated stator.

FIG. 3B is a side view of a laminated stator.

FIG. 4 is a side view of an assembled axial switched reluctance motor with one stator and one rotor.

FIG. 5 is a side view of a laminated stator pole with winding.

FIG. 6 is a side view of a laminated stator with a dovetail-mounted bar steel stator pole with a respective winding.

FIG. 7 is a representation of the angular interface between a laminated rotor pole and a laminated rotor pole with a respective winding.

FIG. 8 is a representation of the V-shaped interface between a laminated rotor pole and a laminated rotor pole with a respective winding.

FIG. 9A is a face view of a stator with 64 stator poles and respective windings.

FIG. 9B is a representation of a controller that generates four phase commutation signals.

FIG. 10 is a representation of an axial switched reluctance motor with one stator, one rotor, and a long flux path.

FIG. 11A is a face view of a stator with 64 stator poles and multiple stator pole sets.

FIG. 11B is a representation of a controller that generates four phase commutation signals.

FIG. 12 is a representation of an axial switched reluctance motor with one stator, one rotor with fewer rotor poles, and a short flux path.

FIG. 13 is a representation of an axial switched reluctance motor with one stator, one rotor with more rotor poles, and a short flux path.

FIG. 14 is a representation of an axial switched reluctance motor with one stator, one rotor with canted rotor poles, and a short flux path.

FIG. 15 is a representation of an axial switched reluctance motor with one stator, one rotor and a short flux path wherein both phase A and phase B are excited by the controller.

FIG. 16 is a representation of an axial switched reluctance motor with one stator and one rotor that includes 7 stator pole sets per phase group.

FIG. 17 is a side view of an assembled axial switched reluctance motor with one stator and two rotors.

FIG. 18 is a representation of an axial switched reluctance motor with one stator, two rotors, and a long flux path.

FIG. 19 is a representation of an axial switched reluctance motor with one stator, two rotors with fewer rotor poles, and a short flux path.

FIG. 20 is a representation of an axial switched reluctance motor with one stator, two rotors with more rotor poles, and a short flux path.

FIG. 21 is a representation of an axial switched reluctance motor with one stator, two rotors with canted rotor poles, and a short flux path.

FIG. 22 is a representation of an axial switched reluctance motor with one stator, two rotors and a short flux path wherein both phase A and phase B are excited by the controller.

FIG. 23 is a representation of an axial switched reluctance motor with one stator and two rotors that includes 7 stator pole sets per phase group.

FIG. 24 is a side view of an assembled axial switched reluctance motor with two stators and one rotor.

FIG. 25A is a representation of an axial switched reluctance motor with two stators and a single long flux path. FIG. 25B is a representation of an axial switched reluctance motor with two stators and two shorter flux paths.

FIG. 26A is a representation of an axial switched reluctance motor with two stators, one rotor with fewer rotor poles, and a short flux path. FIG. 26B is a representation of an axial switched reluctance motor with two stators, one rotor with fewer rotor poles, and a flux path that forms two loops.

FIG. 27 is a representation of an axial switched reluctance motor with two stators, one rotor with more rotor poles, and a short flux path.

FIG. 28 is a representation of an axial switched reluctance motor with two stators, one rotor with canted rotor poles, and a short flux path.

FIG. 29 is a representation of an axial switched reluctance motor with two stators, one rotor and a short flux path wherein both phase A and phase B are excited by the controller.

FIG. 30 is a representation of an axial switched reluctance motor with two stators and one rotor that includes 7 stator pole sets per phase group.

FIG. 31 is a side view of an assembled axial switched reluctance motor with two stators and three rotors.

FIG. 32A is a face view of a stator with 96 stator poles and multiple staggered stator pole sets.

FIG. 32B is a representation of a controller that generates eight phase commutation signals.

FIGS. 33 and 34 are representations of switched reluctance motors with one stator and two rotors where the rotor poles are in phase with one another.

FIG. 35 is a representation of a switched reluctance motor where the rotor poles are in not in phase with one another.

### DETAILED DESCRIPTION

In one embodiment, an axial switched reluctance motor is disclosed. The motor may include a stator and rotor situated about a common axle, i.e. on a common axis. The stator includes multiple stator poles and the rotor includes multiple rotor poles. The stator may include a number of stator pole sets, wherein each stator pole of a stator pole set may exhibit the same phase. In one embodiment, the disclosed axial switched reluctance motor configuration desirably achieves a short flux path between one stator pole and a corresponding rotor pole, the rotor, and another rotor pole, and the remaining stator pole of the stator pole set.

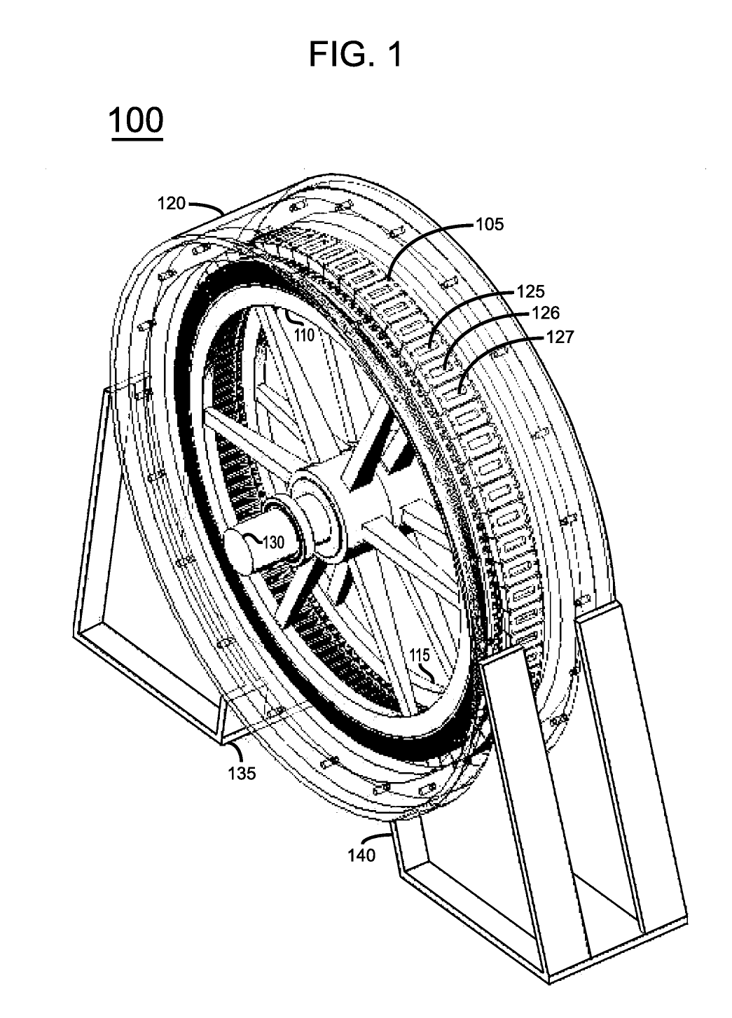

FIG. 1 is a perspective view of an axial switched reluctance motor 100 that includes a stator 105, a rotor 110 and a rotor 115. In one embodiment, stator 105 fixedly attaches to the interior surface of casing 120. Stator 105 may employ multiple stator poles wherein each stator pole includes a stator pole winding. For example, in this particular embodiment, stator 105 may employ representative stator pole windings 125, 126, and 127. Rotor 110 and rotor 115 rotate about a common axis 130 which may also be referred to as an axle. Motor supports 135 and 140 mechanically couple to casing 120 to provide support to axial switched reluctance motor 100.

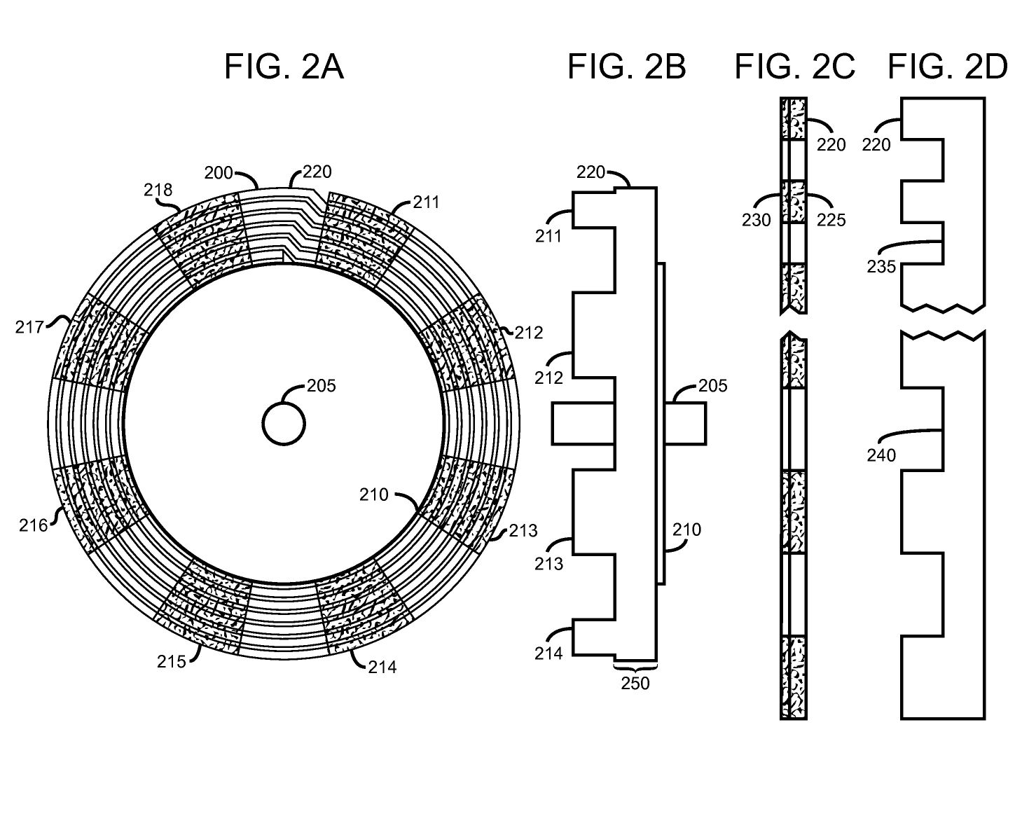

When comparing FIG. 2A, FIG. 2B, FIG. 2C and FIG. 2D, like numbers indicate like elements. FIG. 2A is a face view of rotor 200. Rotor 200 rotates about axis 205 which may also be referred to as an axle. Rotor hub 210, being part of rotor 200, likewise rotates about axis 205. In one embodiment, rotor 200 includes 8 rotor poles, namely rotor poles 211, 212, 213, 214, 215, 216, 217 and 218. Rotor poles 211, 212, 213, 214, 215, 216, 217 and 218.may be evenly radially spaced. In another embodiment, rotor poles 211, 212, 213, 214, 215, 217 and 218 may be radially spaced, as discussed in more detail below.

FIG. 2B is a side view of rotor 200 showing rotor hub 210. The side view of FIG. 2B also show poles 211, 212, 213 and 214. FIG. 2C shows a face view of a laminated member 220 including magnetically permeable metal 225 laminated on an nonmagnetic material 230. While in FIG. 2A and 2C, laminated member 220 is shown with a nonmagnetic material 230 on one side thereof for illustration purposes, in actual practice laminated member 220 may include nonmagnetic material on all sides thereof. For example, a nonmagnetic material 230 may be an enamel or a nonmagnetic oxide on all sides of the magnetically permeable metal 225 of laminated member 220.

In one embodiment, laminated member 220 may be notched to form rotor poles as shown both FIG. 2C and 2D. FIG. 2D is a side view of laminated member 220. Laminated member 220 may be tape wound in one embodiment.

Laminated member 220 is wrapped around rotor hub 210 as shown in FIG. 2A to form rotor poles 211, 212, 213, 214, 215, 216, 217 and 218. In another embodiment, an un-notched laminated member 220 may be wrapped around rotor hub 210, and subsequently notched to form rotor poles 211, 212, 213, 214, 215, 216, 217 and 218. During wrapping of laminated member 220 around rotor hub 210, the radius of the laminated member increases. To compensate for this variation, notches are cut in laminated member 220 such that the size of the notch increases as the arc length of laminated member 220 increases. For example, as seen in FIG. 2D, notch 240 is larger than notch 235. In one embodiment, notches 235 and 240 and other notches may be formed in laminated member 220 prior to coiling the laminated member 220 about rotor hub 210. In another embodiment, notches 235 and 240 and other notches may be formed in laminated member 220 after coiling the laminated member 220 about rotor hub 210. As shown in FIG. 2A taken together with FIG. 2B, 2C and 2D, laminated member 220 wraps around rotor hub 210 to form a coiled laminated rotor back iron assembly 250. In one embodiment, rotor poles 211, 212, 213, 214, 215, 216, 217 and 218 may be laminated and integrated with laminated rotor back iron assembly 250.

In one embodiment, the axial configuration of this motor employs back iron with stacked laminations that form one continuous piece. This configuration may reduce eddy current losses in the magnetic steel that may be used in laminated member 220. This configuration may be achieved by tape winding a continuous strip of magnetic steel upon itself as seen in FIGS. 2A, 2B. Rotor pole pieces may be constructed by either cutting/stamping the strip of magnet steel before winding it on the rotor hub 210 or by cutting, grinding or milling the magnetic steel after it has been wound to form rotor 220 with laminated back iron assembly 250. In one embodiment, this one continuous piece of laminated magnetic steel offers a path for magnetic flux to flow with the least restriction and yet be manufactured easily with fewer parts.

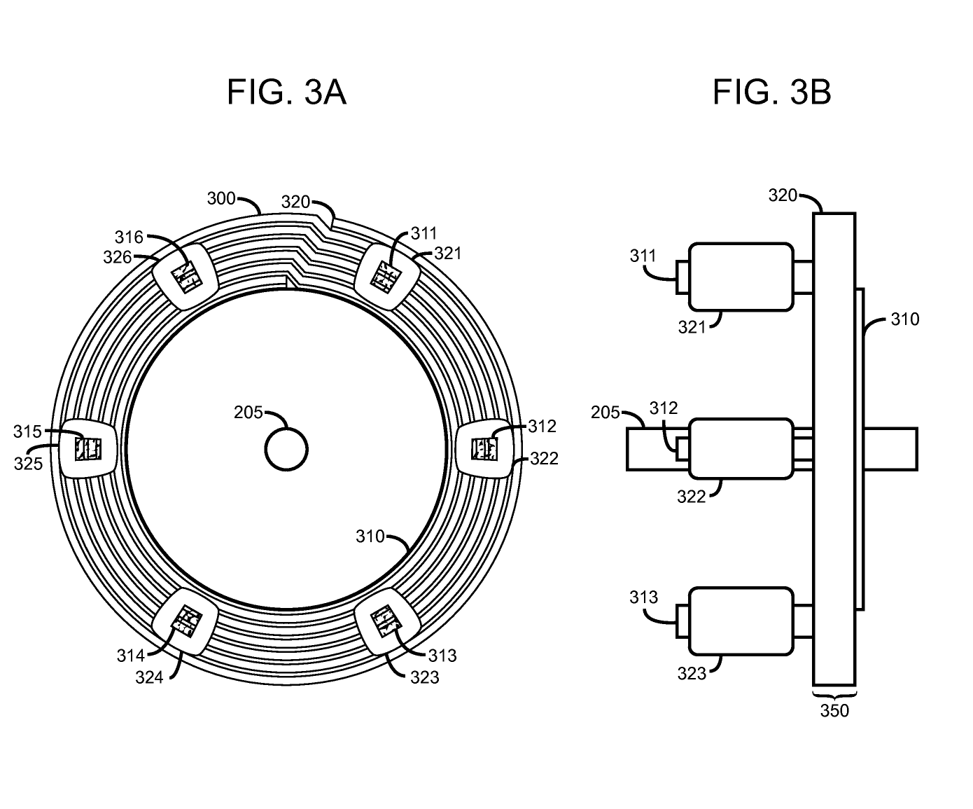

FIG. 3A is a face view of stator 300. FIG. 3B is a side view of stator 300. When comparing FIG. 3A and 3B, like numbers indicate like elements. Whereas rotor 200 rotates about axis 205, stator 300 may be fixed about axis 205 such that it does not rotate with respect thereto. Stator 300 exhibits an axis 205 which is the same axis as rotor 200 when the rotor 200 and stator 300 are assembled to a form an axial switched reluctance motor. Stator 300 includes a stator hub 310. Laminated member 320 is wrapped around stator hub 310 as shown in FIG. 3A to form stator poles 311, 312, 313, 314, 315 and 316. As shown in FIG. 3A taken together with FIG. 3B, laminated member 320 wraps around stator hub 310 to form a coiled laminated stator back iron assembly 350. In one embodiment, stator poles 321, 322, 323, 324, 325 and 326 may be laminated and integrated with laminated stator back iron assembly 350.

In one embodiment, the axial configuration of this motor may employ stator back iron with stacked laminations that form one continuous piece. This configuration may reduce eddy current losses in the magnetic steel that may be used in laminated member 320. This configuration may be achieved by tape winding a continuous strip of magnetic steel upon itself as seen in FIGS. 3A, 3B. Stator pole pieces may be constructed by either cutting/stamping the strip of magnet steel before winding it on the stator hub 310 or by cutting, grinding or milling the magnetic steel after it has been wound to form stator 300 with laminated back iron assembly 350. In one embodiment, this one continuous piece of laminated magnetic steel offers a path for magnetic flux to flow with the least restriction and yet be manufactured easily with fewer parts.

While in FIG. 3A, laminated member 320 is shown with a nonmagnetic material on one side thereof for illustration purposes, in actual practice laminated member 320 may include nonmagnetic material on all sides thereof. For example, a nonmagnetic material may be an enamel or a nonmagnetic oxide on all sides of the magnetically permeable metal of laminated member 320.

In one embodiment, stator poles 321, 322, 323, 324, 325 and 326 are wound around stator poles 311, 312, 313, 314, 315 and 316, respectively, to supply the magnetic flux.

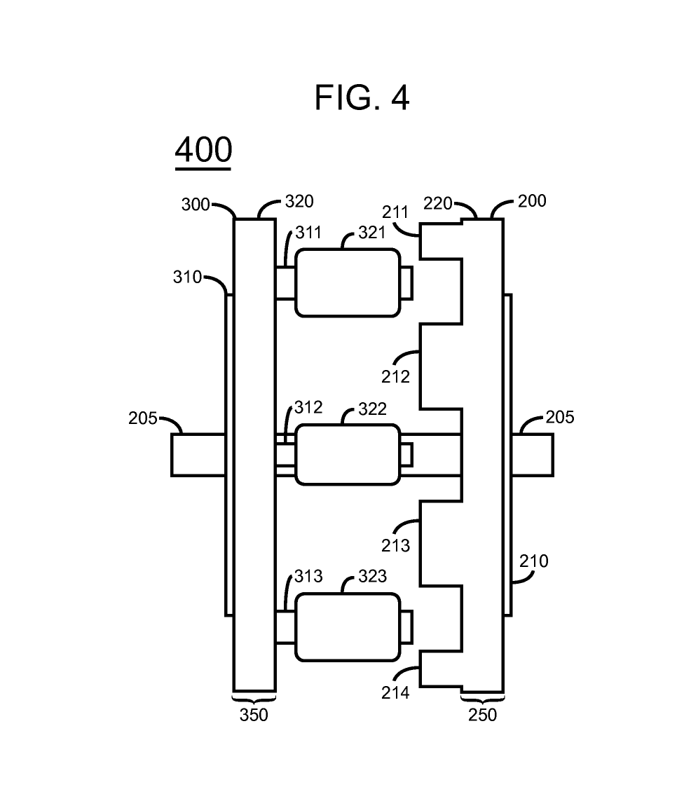

FIG. 4 is a side view of an assembled axial switched reluctance motor 400 including one state and one rotor. More particularly, motor 400 includes axle 205 (i.e. an axis), rotor 200 and stator 300. Like numbers indicate like elements when comparing FIGS. 2A-2D, 3A-3B and 4.

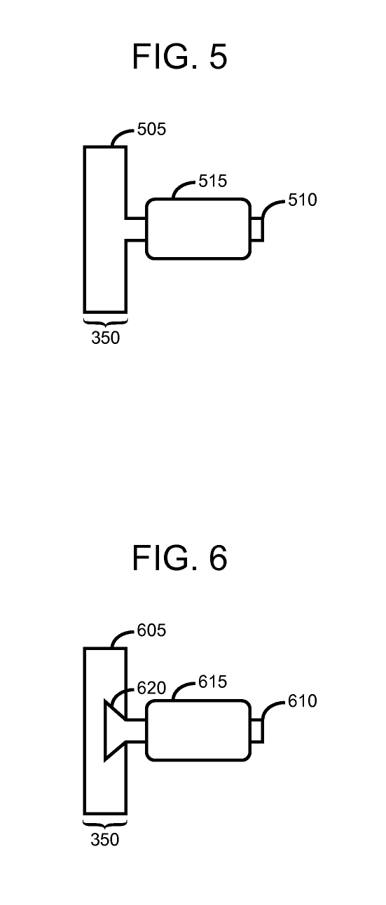

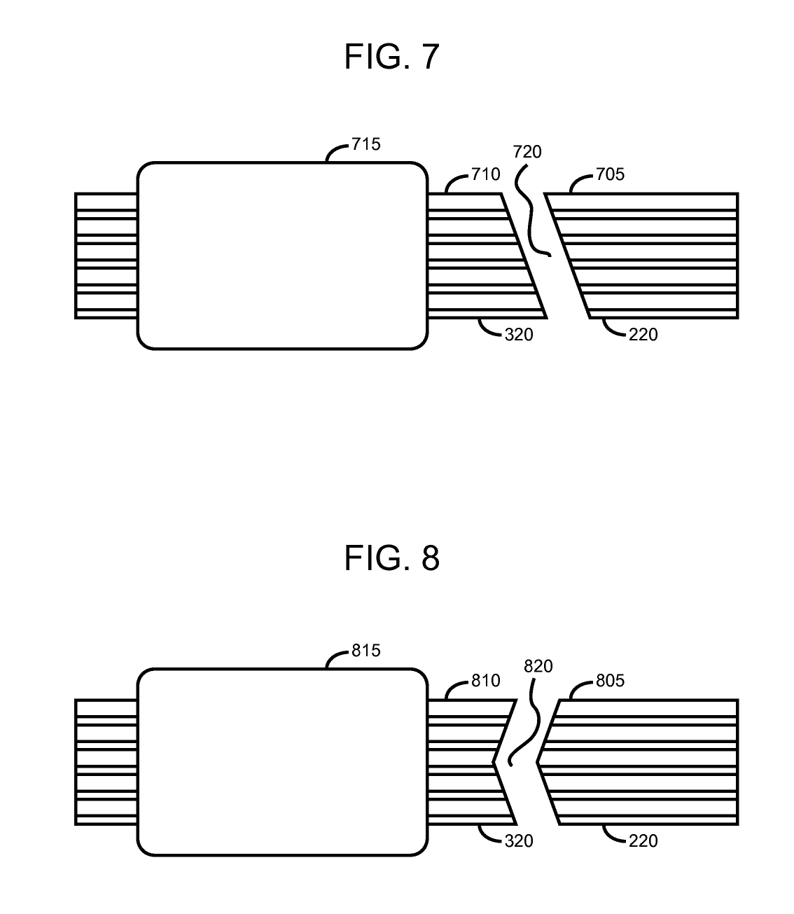

FIG. 5 and FIG. 6 show two different ways of forming laminated stator poles, such as stator pole 311. FIG. 5 shows a side view of a laminated stator 505 with a laminated stator pole 510 and respective winding 515 that may be constructed in a manner similar to the formation of laminated rotor poles discussed above FIG. 2A-2D. Like numbers indicate like elements when comparing FIGS. 3A-3B and FIGS. 5 and 6.

FIG. 6 is a side view of a laminated stator 605 with a dovetail-mounted bar steel stator pole 610 and respective winding 615. A dovetail-shaped notch 620 is cut into the laminated stator 605 into which dovetail-mounted bar steel stator pole 610 is placed. This arrangement results in lower amounts of waste material. The axial motor stator back iron design of FIG. 6 may employ dovetailed sections 620 to allow preassembled stator pole pieces with windings upon a lamination stack with one end including the corresponding dovetailed end as shown. These separate pole piece assemblies allow for easier winding of the coils and better copper fill for winding 615.

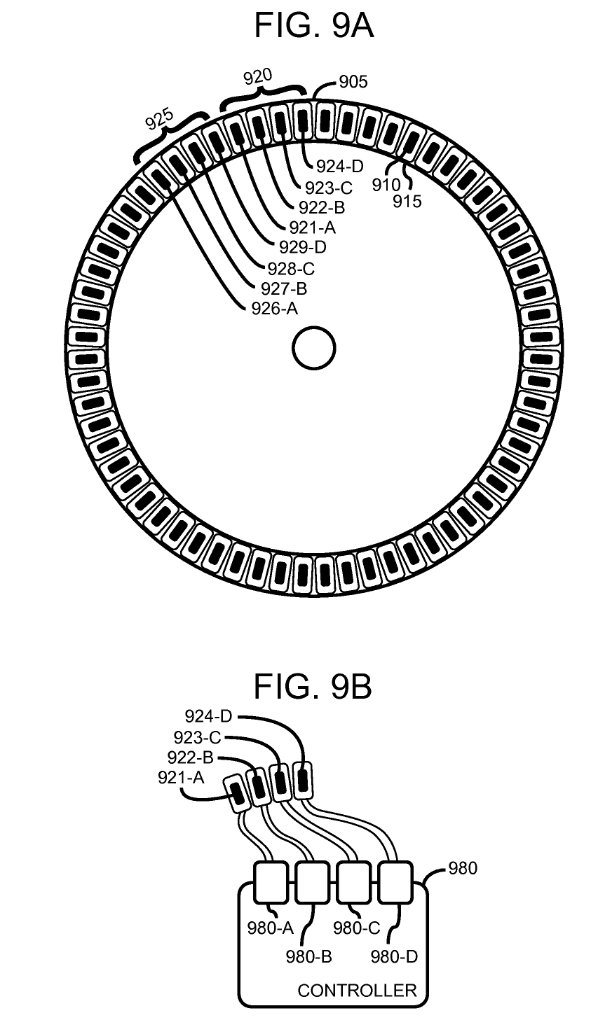

FIG. 7 is a representation of the interface between a rotor pole 705 and a stator pole 710 and a respective winding 715. Rather than a 90-degree cut between the rotor pole and stator pole as shown in FIG. 4, this embodiment exhibits an angle greater than 90 degrees, thus increasing the surface area of the interface 720 between rotor pole 705 and stator pole 710. This action may decrease the flux density at the laminated rotor pole 705. Advantageously, this configuration allows less metal to be employed in rotor pole 805. The stator pole and rotor pole interface 720 may be formed with an angled geometry as illustrated to allow more air gap surface area to improve motor operating characteristics. In FIG. 7 the rotor pole 705 and the stator pole 710 may be fabricated of magnetic steel that includes nonmagnetic material on all sides thereof.

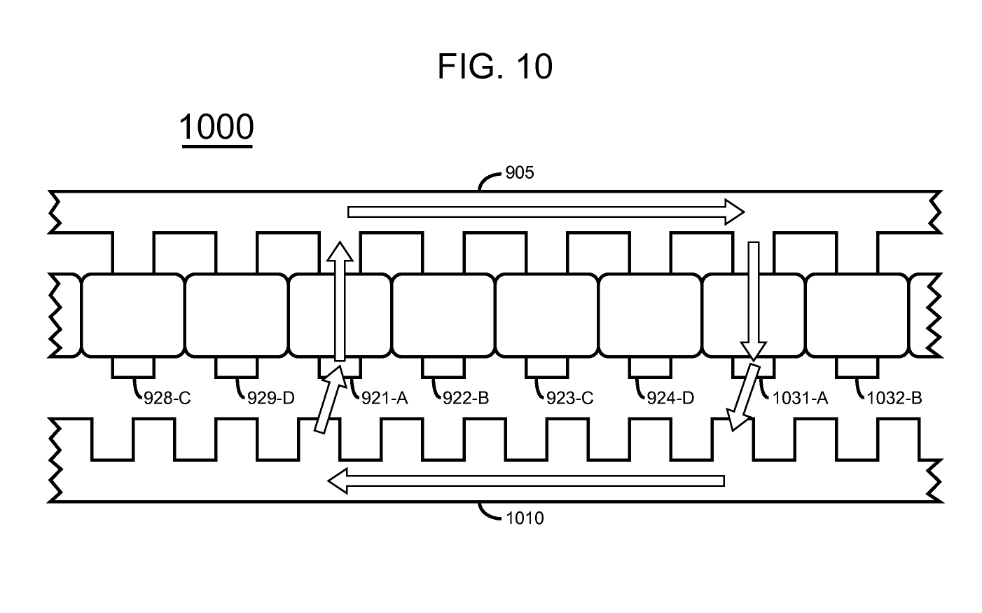

FIG. 8 is a representation of the interface between a rotor pole 805 and a stator pole 810 and a respective winding 815. Rather than a 90 degree cut between the rotor pole and stator pole as shown in FIG. 4, this embodiment exhibits an V-shaped cut that increases the surface area of the interface between rotor pole 805 and stator pole 810. This action may decrease flux density at the laminated rotor pole 805. In FIG. 8 the rotor pole 805 and the stator pole 810 may be fabricated of magnetic steel that includes nonmagnetic material on all sides thereof.

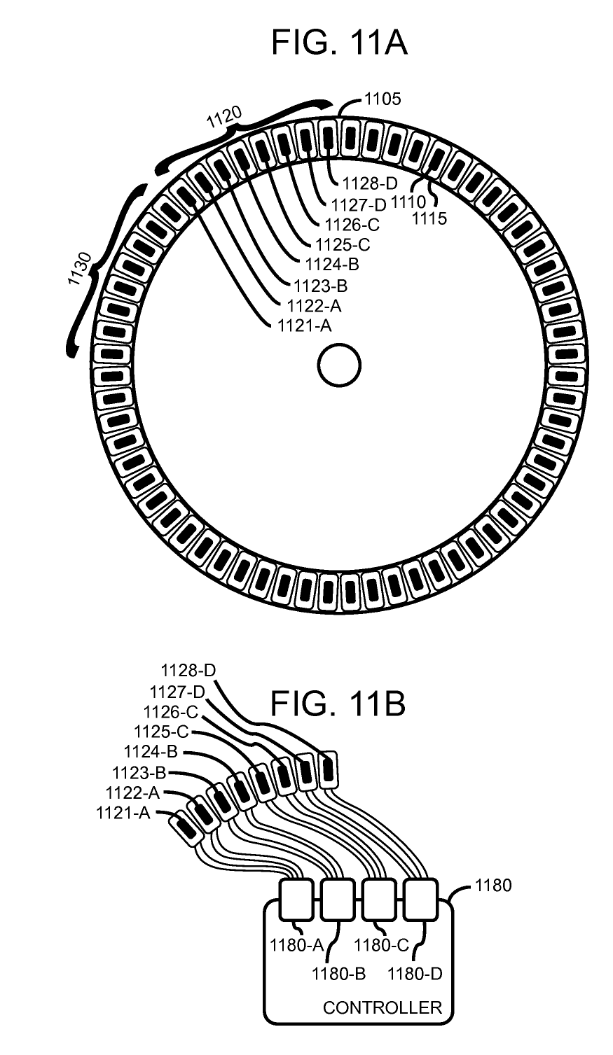

FIG. 9A is a face view of a stator 905 that employs 64 stator poles, such as stator pole 910, with respective coil windings 915. Stator 905 includes two representative non-set phase groups 920 and 925, as well as other non-set phase groups not illustrated. Non-set phase group 920 includes stator poles 921-A, 922-B, 923-C and 924-D. Non-set phase group 925 includes stator poles 926-A, 927-B, 928-C and 929-D. FIG. 9B shows a controller 980 that includes phase outputs 980-A, 980-B, 980-C and 980-D that generate respective phase commutation signals phase A, phase B, phase C and phase D for stator poles 921-A, 922-B, 923-C and 924-D, respectively. Controller 980 generates these commutation signals phase A, phase B, phase C and phase D to activate respective stator poles. Poles of like phase may all be energized at the same time. While FIG. 9A only shows 2 phase groups, the pattern of phase groups repeats all the way around stator 905. Stated alternatively, stator 905 consists of four electrical phases that form two groupings 920 and 925. Group 920 has the coils arranged in phase order with stator poles 921-A, 922-B, 923-C and 924-D. Group 925 has the coils arranged in phase order with stator poles 926A, 927B, 928C and 929D.

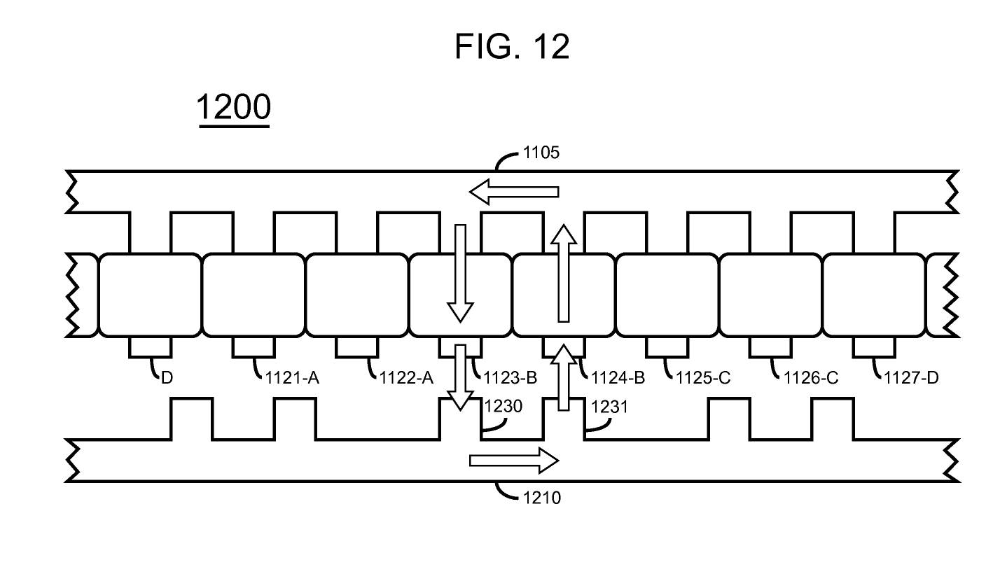

FIG. 10 is a representation of an axial switched reluctance motor 1000 that includes a stator 905 and a rotor 1010. Stator 905 includes stator poles 921-A, 922-B, 923-C and 924-D that together form a non-set phase group. Stator 905 also includes stator poles 1031-A and 1032-B that together form a portion of another non-set phase group. Stator 905 also includes stator poles 928-C and 929-D that together form a portion of yet another non-set phase group. This arrangement follows the phase pattern of stator 905 of FIG. 9A. This is an example of a long flux path that travels from one phase group to another phase group to complete. More particularly, the flux path travels from stator pole 921-A, through stator 905, through stator pole 1031-A, through a rotor pole on rotor 1010, through rotor 1010, through another rotor pole on rotor 1010 and back to stator pole 921-A. In this embodiment, motor 1000 exhibits more rotor poles than stator poles.

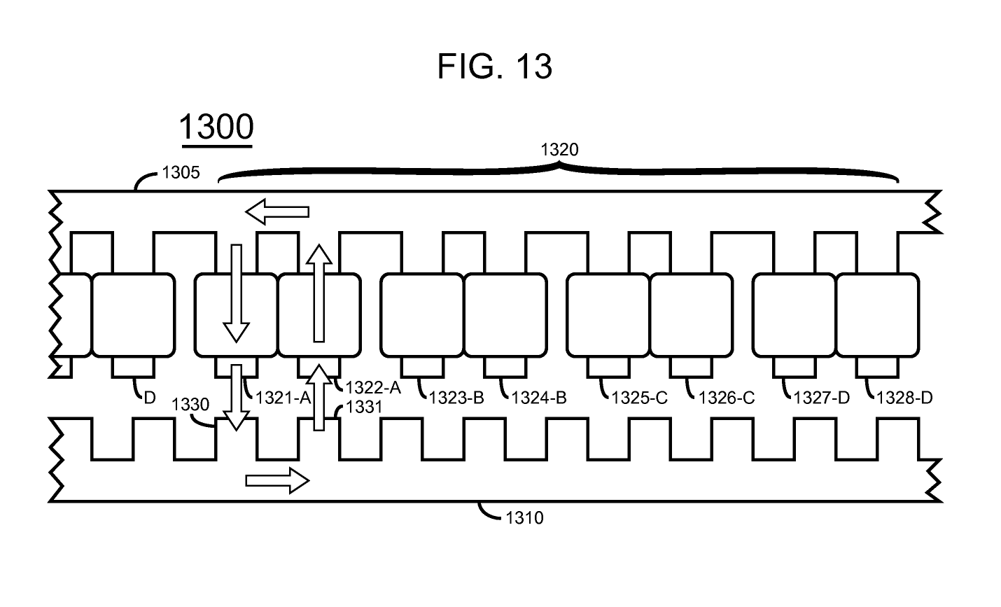

FIG. 11A is a face view of the disclosed stator 1105 that employs 64 stator poles, such as stator pole 1110, with respective coil winding 1115. Stator 1105 includes two representative phase groups 1120 and 1130, as well as other phase groups not illustrated. Phase group 1120 includes stator poles 1121-A, 1122-A, 1123-B, 1124-B, 1125-C, 1126-C, 1127-D, and 1128-D. Within each phase group, adjacent stator poles that exhibit the same phase are “stator pole sets”. For example, in phase group 1120, stator pole 1121-A and stator pole 1122-A exhibit the same phase and are adjacent, and thus form a stator pole set. In this particular example, there are four phases in each phase group. In one embodiment, the stator pole pattern that phase group 1120 exhibits repeats for phase group 1130, and other phase groups around the entire circumference of stator 1105 although those phase groups are shown but not specifically labeled. Stator poles 1121-A,1122-A effectively provide stator phase coils that are adjacent one another. Likewise stator poles 1123-B,1124-B effectively provide stator phase coils that are adjacent one another. The same adjacency applies to stator poles 1125-C,1126-C, and stator poles 1127-D, 1128-D. While FIG. 11A only shows 2 phase groups, the pattern of phase groups repeats all the way around stator 1105.

FIG. 11B shows a controller 1180 that includes phase outputs 1180-A, 1180-B, 1180-C and 1180-D that generate respective phase commutation signals phase A, phase B, phase C and phase D for stator poles “1121-A, 1122-A”, “1123-B, 1124-B”, “1125-C, 1126-C”, “1127-D and 1128-D”, respectively. Controller 1180 generates these commutation signals phase A, phase B, phase C and phase D to activate respective stator poles. Poles of like phase may all be energized at the same time. Alternatively, each stator pole set (SPS(may be controlled individually by controller 1180.

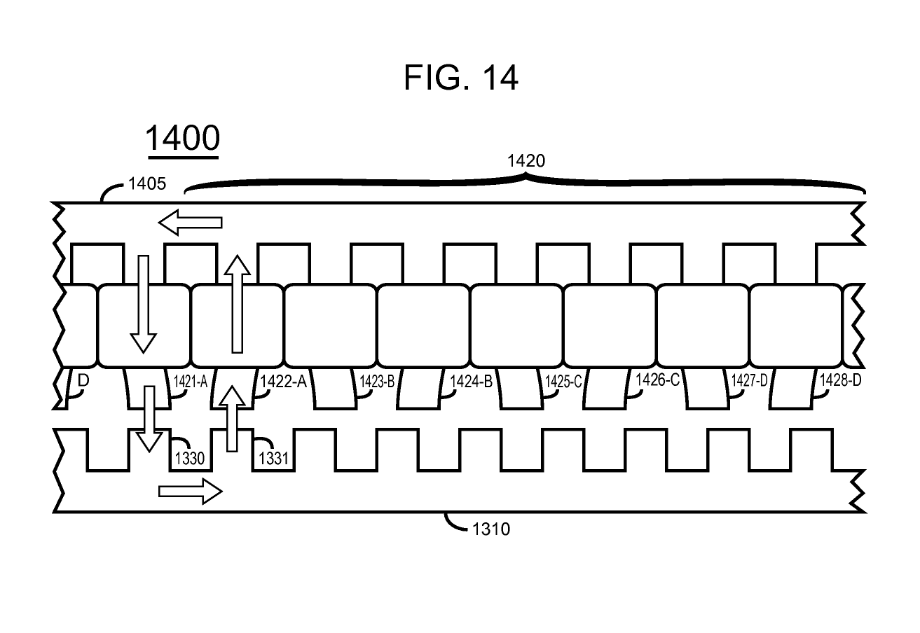

FIG. 12 is a representation of the disclosed axial switched reluctance motor 1200 that includes a stator 1105 and a rotor 1210. Stator 1105 includes stator poles 1121-A, 1122-A, 1123-B, 1124-B, 1125-C, 1126-C, 1127-D and 1128-D (not shown in FIG. 12 but shown in FIG. 11) that together form a phase group. Stator 1105 also includes stator pole D that is a portion of another phase group. This arrangement follows the phase pattern of stator 1105 of FIG. 11A. Motor 1200 exhibits a short flux path. More particularly, the flux path travels from stator pole 1123-B, through rotor 1210, through stator pole 1124-B, trough stator 1105, and back to stator pole 1123-B to form a complete short flux path. This short flux path stays within the stator pole set within the phase group 1120 and does not travel outside phase group 1120 in contrast to the long flux path of FIG. 10.

In this embodiment, rotor 1210 exhibits fewer rotor poles than stator poles. This configuration permits motor 1200 to exhibit a higher top speed. Moreover, in one embodiment, rotor 1210 includes rotor pole sets. For example, rotor 1210 includes a rotor pole set having rotor poles 1230 and 1231. When rotor poles 1230 and 1231 are aligned with stator poles 1123-B and 1124-B, all stator pole sets that are phase B are aligned with rotor poles. Similarly, when rotor poles 1230 and 1231 are aligned with stator poles 1121-A and 1122-A, all stator pole sets that are phase A are aligned with rotor poles. In one embodiment, this relationship continues with all other phases of phase group 1120. Likewise, this relationship also applies to all phase groups of stator 1105 with respect to rotor 1210.

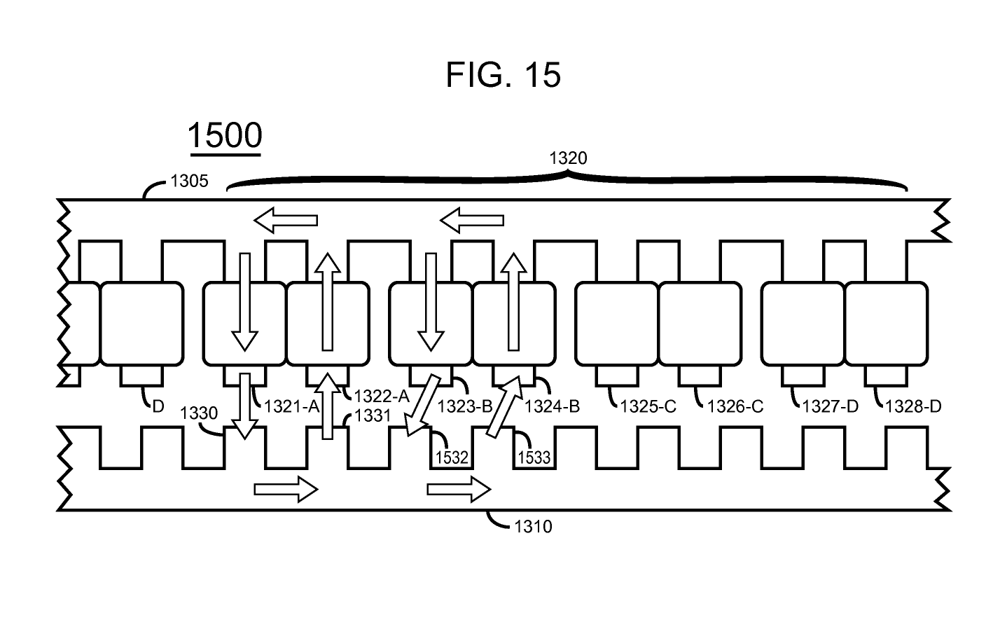

FIG. 13 shows a switched reluctance motor 1300 with the same phase groups as motor 1205, namely phase A, B, C and D. However, motor 1300 includes a stator 1305 that exhibits spacing different from that of motor 1200 and a rotor 1310 that exhibits spacing different from that of rotor 1210. Rotor 1310 includes more poles than stator 1305. Thus, motor 1300 may be slower than motor 1200. Moreover, in one embodiment, rotor 1310 includes rotor pole sets. For example, rotor 1310 includes a rotor pole set having rotor poles 1330 and 1331. When rotor poles 1330 and 1331 are aligned with stator poles 1323-B and 1324-B, all stator pole sets that are phase B are aligned with rotor poles. Similarly, when rotor poles 1330 and 1331 are aligned with stator poles 1321-A and 1322-A, all stator pole sets that are phase A are aligned with rotor poles. In one embodiment, this relationship continues with all other phases of phase group 1320. Likewise, this relationship also applies to all phase groups of stator 1305 with respect to rotor 1310.

In more detail, FIG. 13 is a representation of the disclosed axial switched reluctance motor 1300 that includes a stator 1305 and a rotor 1310. Stator 1305 includes stator poles 1321-A, 1322-A, 1323-B, 1324-B, 1325-C, 1326-C, 1327-D and 1328-D that together form a phase group. Stator 1305 also includes stator pole D that is a portion of another phase group. This arrangement follows the phase pattern of stator 1105 of FIG. 11A. Motor 1300 exhibits a short flux path. More particularly, the flux path travels from stator pole 1321-A, through rotor pole 1330, through rotor 1310, through rotor pole 1331, through stator pole 1322-A, through stator 1305, and back to stator pole 1321-A to form a complete short flux path. This short flux path stays within the stator pole set within the phase group and does not travel outside the phase group in contrast to the long flux path of FIG. 10.

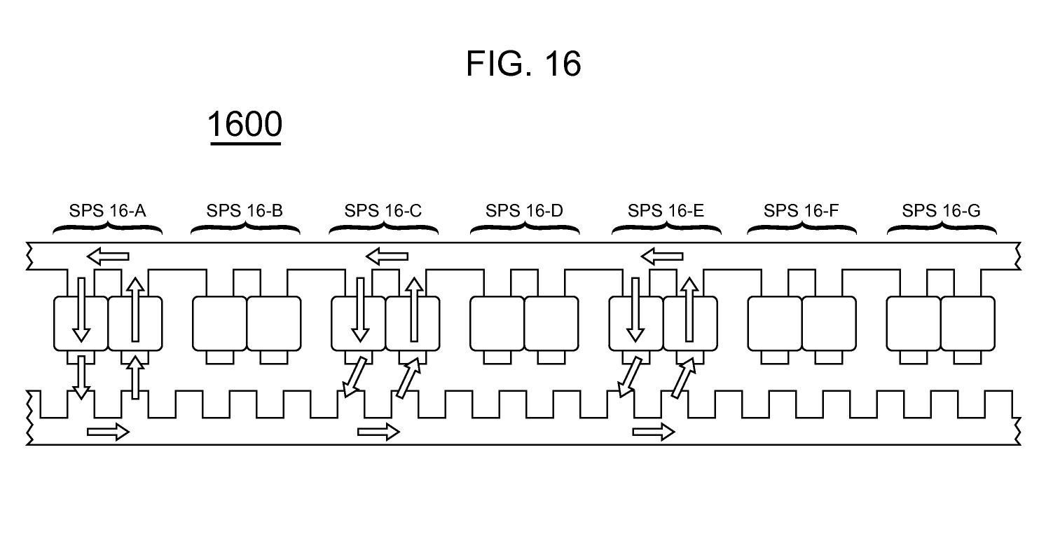

FIG. 14 shows an axial switched reluctance motor 1400 which is similar to motor 1300 of FIG. 13 with like number indicating like elements, except that the stator poles of stator 1405 are canted to accommodate a larger coiled winding thereon. This arrangement generates more flux in the stator poles in comparison to the stator poles of motor 1300. Stator 1405 includes stator poles 1421-A, 1422-A, 1423-B, 1424-B, 1425-C, 1426-C, 1427-D and 1428-D that together form a phase group 1420. Stator 1405 also includes stator pole D that is a portion of another phase group.

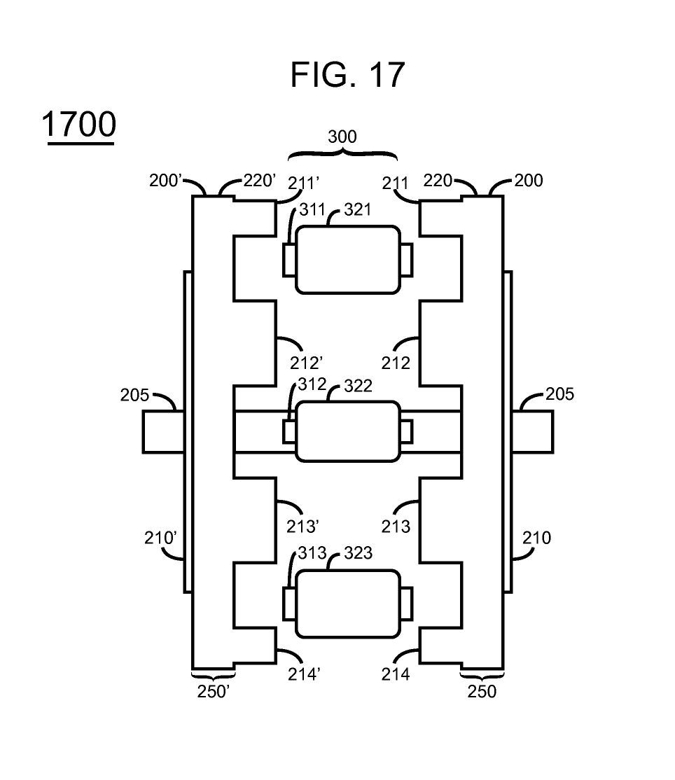

FIG. 15 shows an axial switched reluctance motor 1500 which is similar to motor 1300 except that phase A and phase B are excited by controller 1180 at the same time. In this embodiment, controller 1180 excites two phases at the same time. More particularly, the phase A flux path travels from stator pole 1321-A, through rotor pole 1330, through rotor 1310, through rotor pole 1331, through stator pole 1322-A, through stator 1305, and back to stator pole 1321-A to form a complete short flux path. This short flux path stays within the stator pole set within the phase group and does not travel outside the phase group in contrast to the long flux path of FIG. 10. The phase B flux path travels from stator pole 1323-B, through rotor pole 1532, through rotor 1310, through rotor pole 1533, through stator pole 1324-B, through stator 1305, and back to stator pole 1323-B to form a complete short flux path. In this embodiment, this short flux path stays within the stator pole set within the phase group and does not travel outside the phase group in contrast to the long flux path of FIG. 10. In this embodiment, due to partial misalignment phase B does not impart as much force as phase A which is in full alignment. Phases C and D are off in time snapshot that FIG. 15

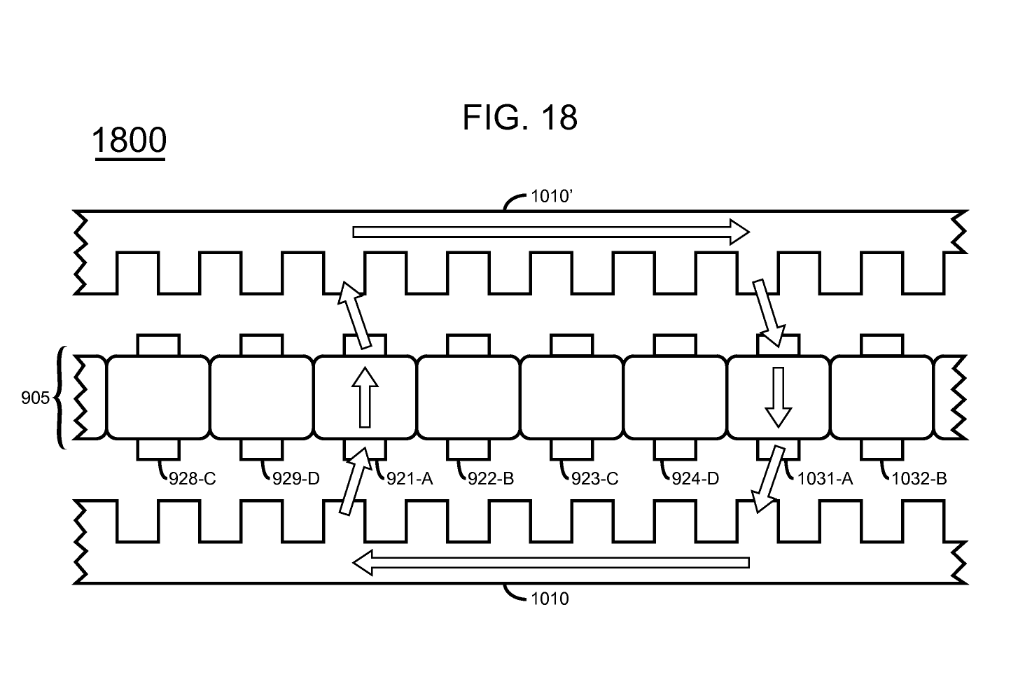

FIG. 16 shows an axial switched reluctance motor 1600 which is similar to motor 1500 except that motor 1600 includes 7 stator pole sets (SPSs) per phase group instead of 4 stator pole sets (SPSs) per phase group that motor 1500 employs. More particularly, motor 1600 includes stator pole sets (SPSs), namely SPS 16-A, SPS 16-B, SPS 16-C, SPS 16-D, SPS 16-E, SPS 16-F and SPS 16-G, as illustrated. SPS 16-A, SPS 16-C and SPS 16-E are excited by a controller to generate respective flux paths designated by arrows adjacent SPS 16-A, SPS 16-C and SPS 16-E, as illustrated.

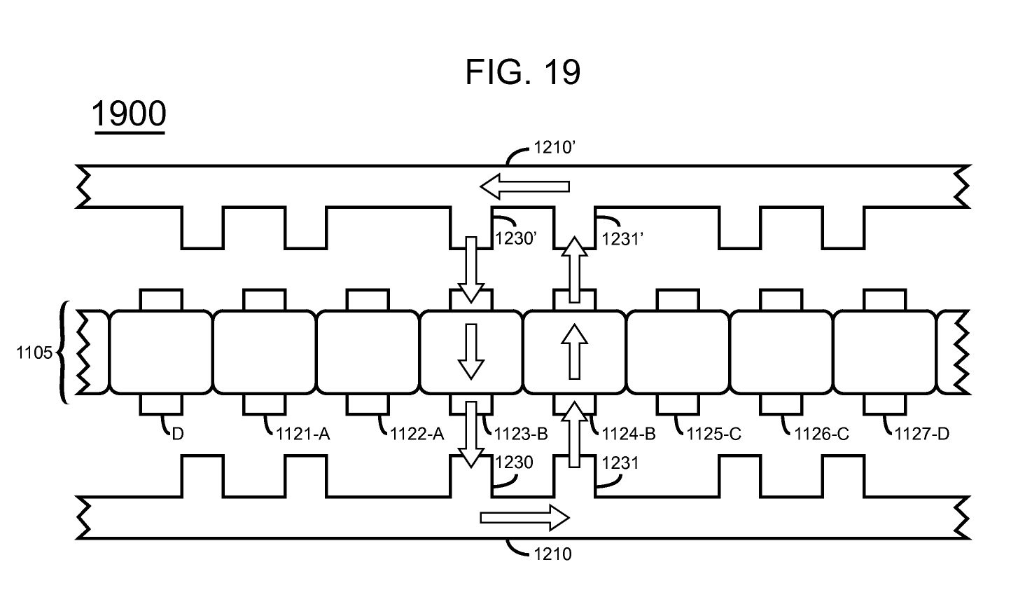

FIG. 17 shows another axial switched reluctance motor 1700 that is similar to the one rotor/one stator motor 400 of FIG. 4, except that motor 1700 includes two rotors. Motor 1700 is thus a two rotor/one stator motor. In more detail, motor 1700 includes stator 300, rotor 200 and an additional rotor 200′. Like numbers indicate like elements when comparing FIGS. 2A-2D, 3A-3B and 17.

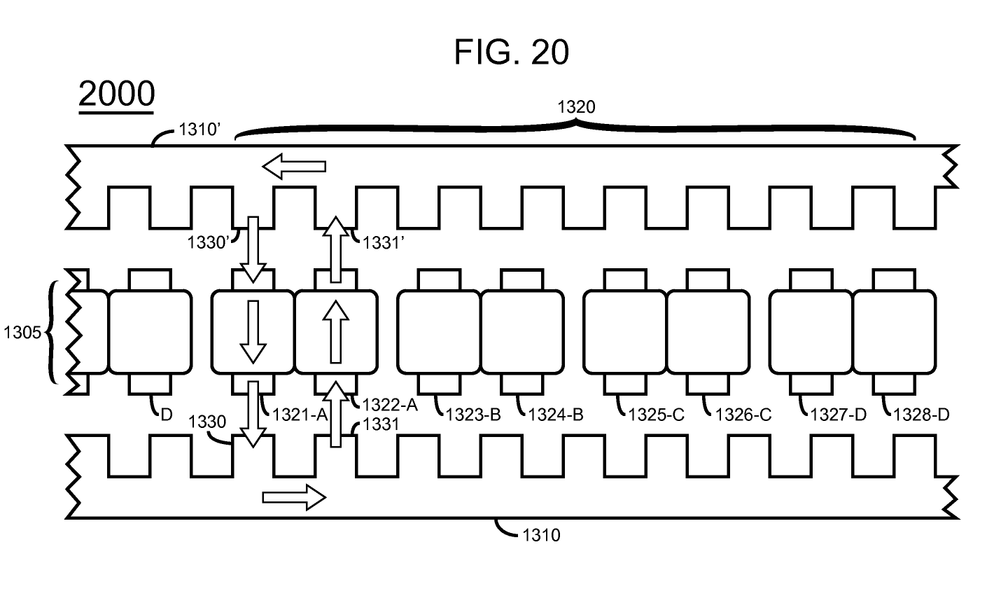

FIG. 18 shows yet another axial switched reluctance motor 1800 that is similar to the one rotor/one stator motor 1000 of FIG. 10 except that motor 1800 includes two rotors. Motor 1800 is thus a two rotor/one stator motor wherein the short flux path indicated by arrows goes through both rotors 1010 and 1010′ and through stator 905.

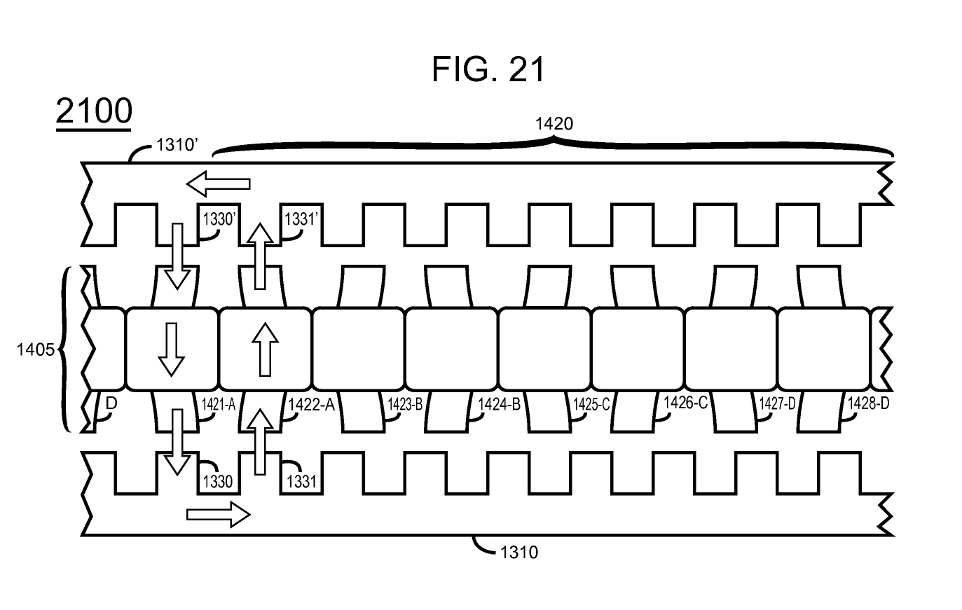

FIG. 19 show another axial switched reluctance motor 1900 that is similar to one rotor/one stator motor 1200 of FIG. 12, except that motor 1900 includes two rotors. Motor 1900 is thus a two rotor/one stator motor wherein the short flux path indicated by arrows goes through both rotors 1210 and 1210′ and through stator 1105.

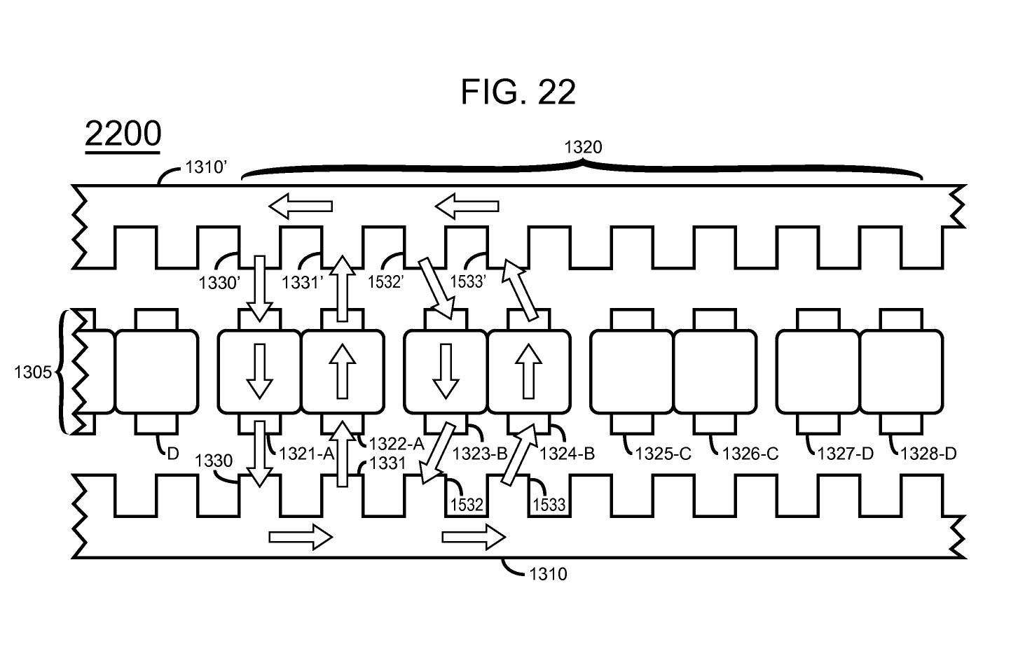

FIG. 20 shows yet another axial switched reluctance motor 2000 that is similar to one rotor/one stator motor 1300 of FIG. 13, except that motor 2000 includes two rotors. Motor 2000 is thus a two rotor/one stator motor wherein the short flux path indicated by arrows goes through both rotors 1310 and 1310′ and through stator 1305.

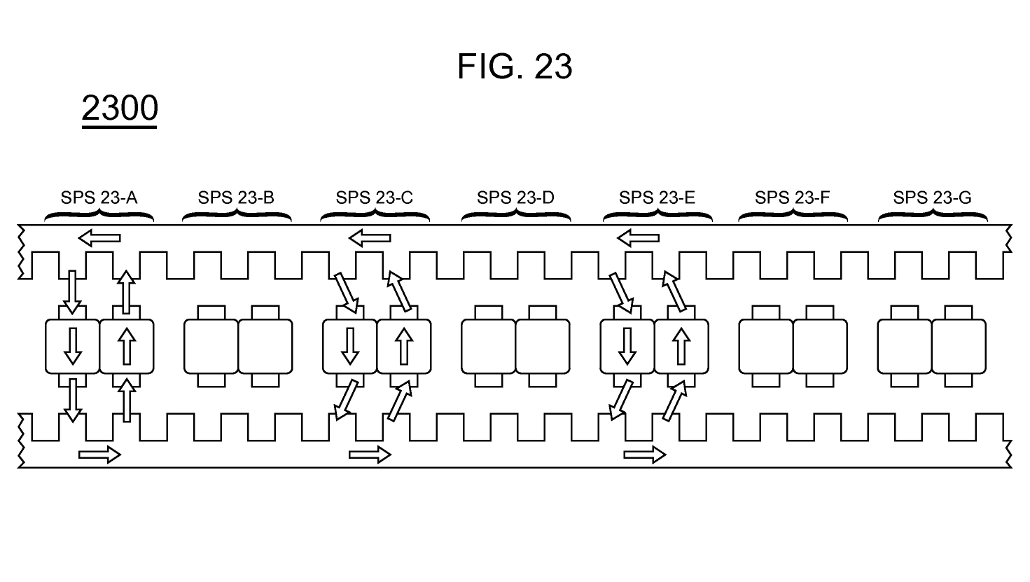

FIG. 21 shows another axial switched reluctance motor 2100 that is similar to one rotor/one stator motor 1400 of FIG. 14, except that motor 2100 includes two rotors. Motor 2100 is thus a two rotor/one stator motor wherein the short flux path indicated by arrows goes through both rotors 1310 and 1310′ and through stator 1405.

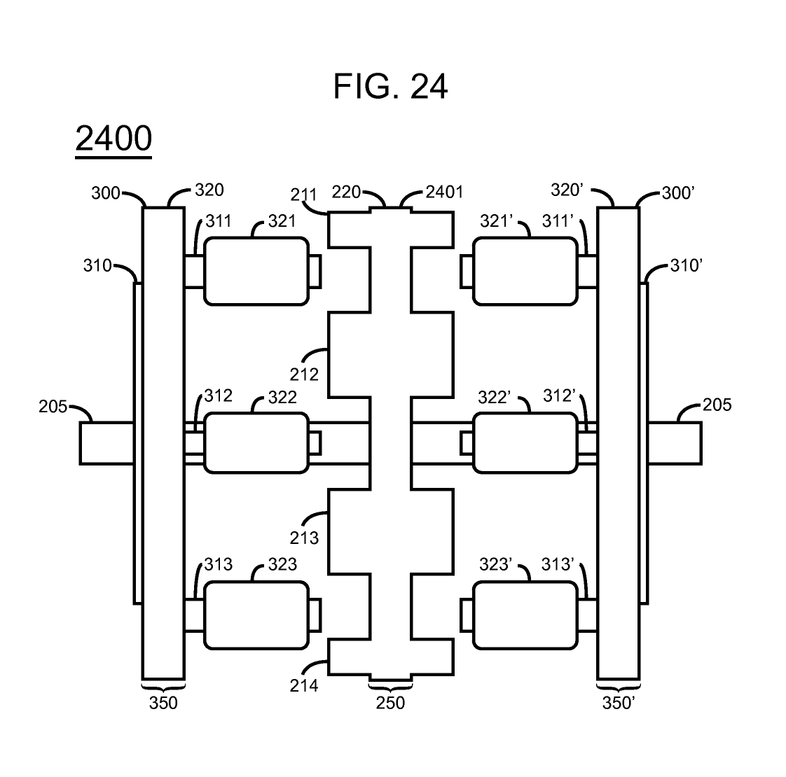

FIG. 22 shows yet another axial switched reluctance motor 2200 that is similar to one rotor/one stator motor 1500 of FIG. 15, except that motor 2100 includes two rotors. Motor 2200 is thus a two rotor/one stator motor wherein the short flux path indicated by arrows goes through both rotors 1310 and 1310′ and through stator 1305.

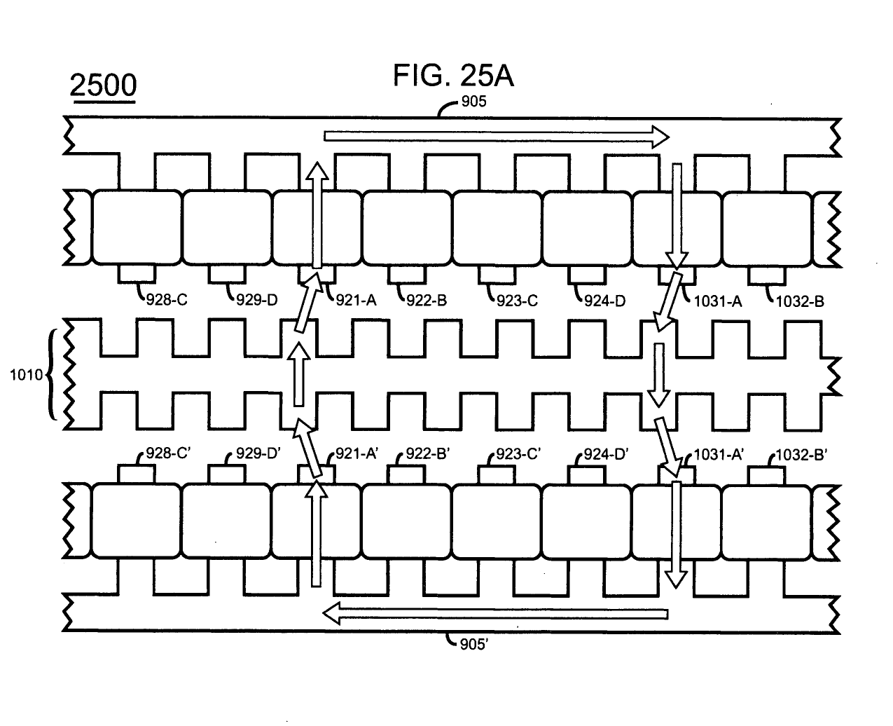

FIG. 23 shows another axial switched reluctance motor 2300 that is similar to one rotor/one stator motor 1600 of FIG. 16, except that motor 2300 includes two rotors and exhibits 7 stator pole sets (SPSs) per phase group instead of 4 stator pole sets (SPSs) per phase group that motor 1600 employs. More particularly, motor 2300 includes stator pole sets (SPSs), namely SPS 23-A, SPS 23-B, SPS 23-C, SPS 23-D, SPS 23-E, SPS 23-F and SPS 23-G, as illustrated. Motor 2300 is thus a two rotor/one stator motor wherein the short flux path indicated by arrows goes through both rotors and through the stator. SPS 23-A, SPS 23-C and SPS 23-E are excited by a controller to generate respective flux paths designated by arrows adjacent SPS 23-A, SPS 23-C and SBS 23-E, as illustrated.

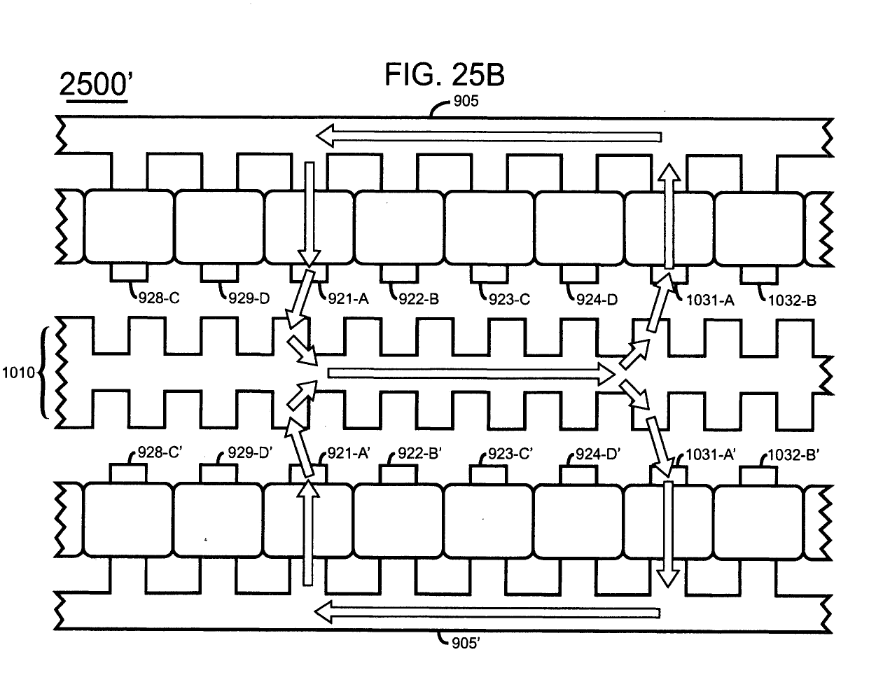

FIG. 24 shows another axial switched reluctance motor 2400 that is similar to the one rotor/one stator motor 400 of FIG. 4, except that motor 2400 includes two stators. Motor 2400 is thus a two stator/one rotor motor. In more detail, motor 2400 includes rotor 200, stator 300 and an additional stator 300′. Rotor 2401 may be similar to rotor 200 but with rotor poles extending from the opposed sides thereof as illustrated in FIG. 24. Like numbers indicate like elements when comparing FIGS. 2A-2D, 3A-3B and 24.

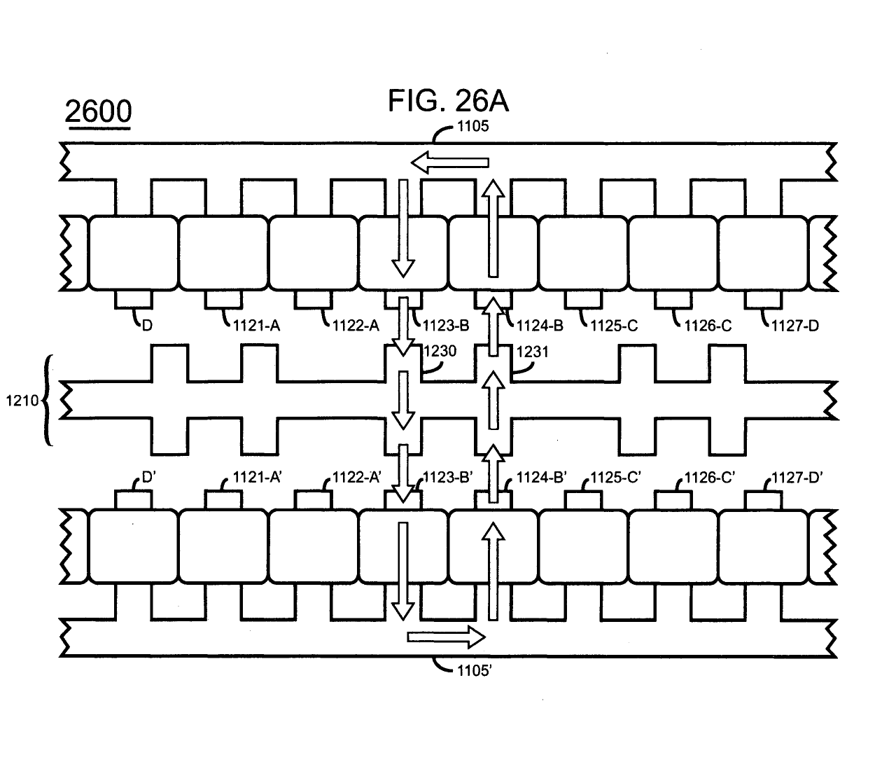

FIG. 25A shows yet another axial switched reluctance motor 2500 that is similar to the one rotor/one stator motor 1000 of FIG. 10 except that motor 2500 includes two stators. Motor 2500 is thus a two stator/one rotor motor wherein the short flux path indicated by arrows goes through both stators 905 and 905′ and through rotor 1010, thus forming a single flux loop path.

FIG. 25B shows yet another axial switched reluctance motor 2500′ that is similar motor 2500 of FIG. 25A except flux path exhibits two loops. More particularly, motor 2500′ includes a first counterclockwise flux path loop between stator 905 and rotor 1010, and a second clockwise flux path loop between stator 905′ and rotor 1010.

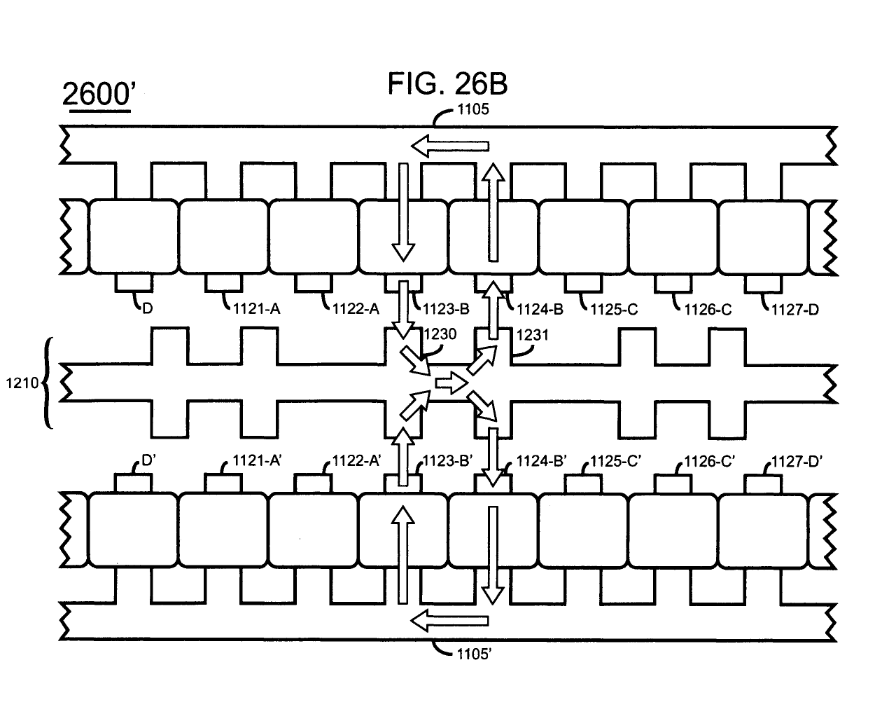

FIG. 26A show another axial switched reluctance motor 2600 that is similar to one rotor/one stator motor 1200 of FIG. 12, except that motor 2600 includes two stators. Motor 1900 is thus a two stator/one rotor motor wherein the short flux path indicated by arrows goes through stator 1105, rotor 1210, and an additional stator 1105′.

FIG. 26B show another axial switched reluctance motor 2600′ that is similar to motor 2600 of FIG. 26A, except that the flux path indicated by arrows exhibits two loops. More particularly, motor 2600′ includes a first counterclockwise flux path loop between stator 1105 and rotor 1210, and a second clockwise flux path loop between stator 1105′ and rotor 1210.

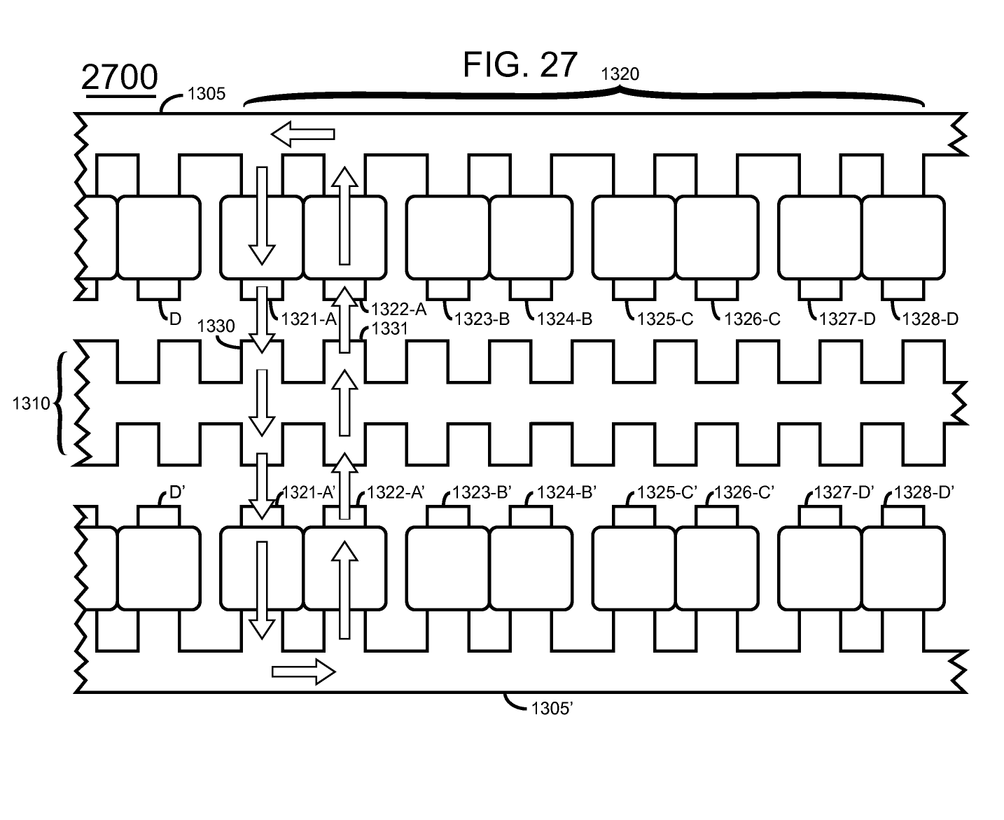

FIG. 27 shows yet another axial switched reluctance motor 2700 that is similar to one rotor/one stator motor 1300 of FIG. 13, except that motor 2700 includes two stators. Motor 2700 is thus a two stator/one rotor motor wherein the short flux path indicated by arrows goes through stator 1305, rotor 1310 and an additional stator 1305′ as indicated by the arrows in FIG. 27.

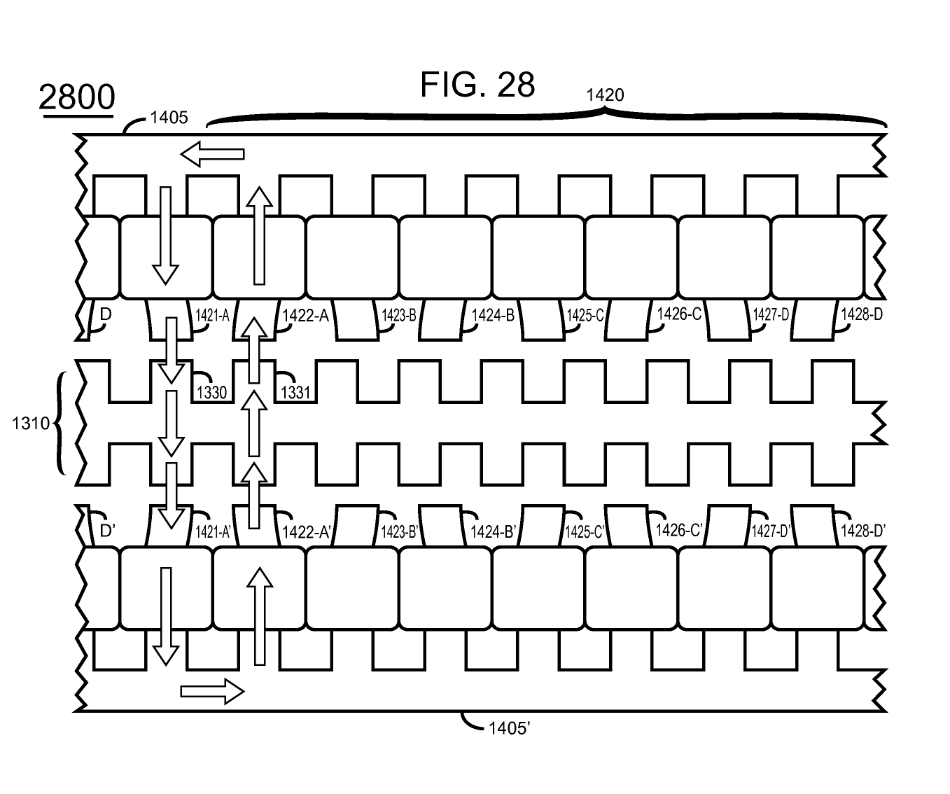

FIG. 28 shows another axial switched reluctance motor 2800 that is similar to one rotor/two stator motor 2700 of FIG. 27, except that motor 2800 includes stator poles 1421A and 1422-A that are canted to permit a larger coil to be wound thereon. In a similar manner, stator poles 1421-A′ and 1422-A′ are canted to permit a larger coil to be wound thereon.

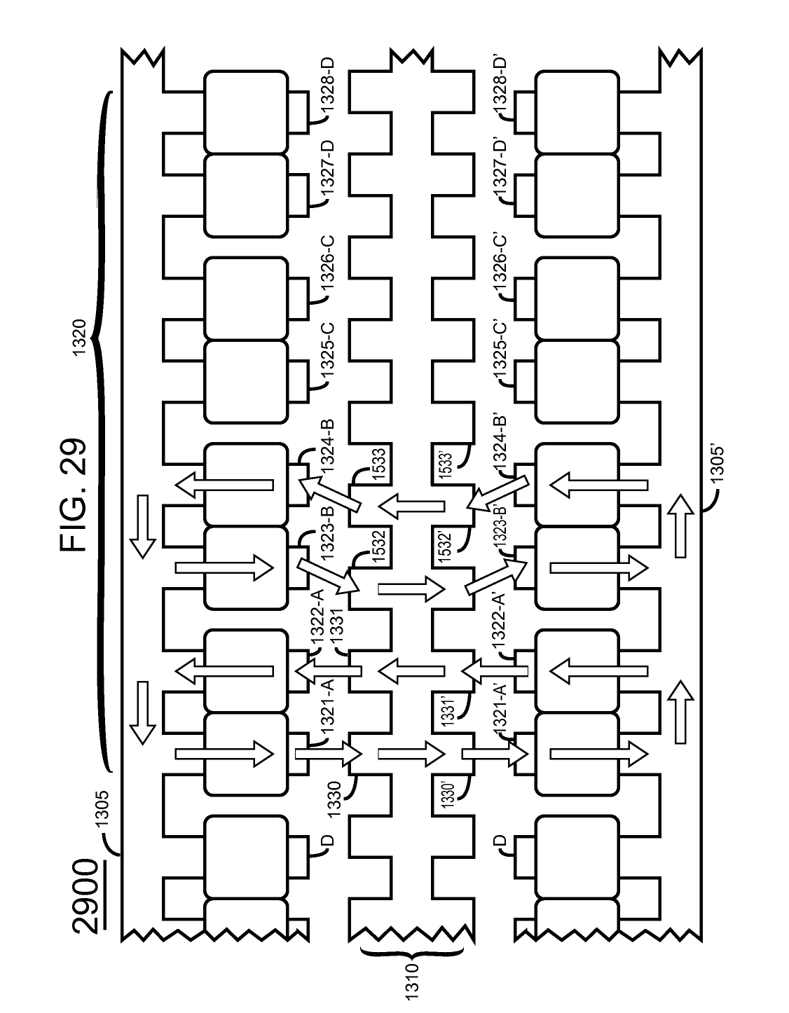

FIG. 29 is yet another axial switched reluctance motor 2900 that is similar to one rotor/one stator motor 1500 of FIG. 15, except that motor 2900 includes two stators. Motor 2900 is thus a one rotor/two stator motor wherein a first short flux path indicated by arrows goes through stator 1321-A, rotor 1310, and through stator 1321-A′. More particularly, the first flux path extends from stator pole 1321-A, through rotor pole 1330, through rotor 1310, through rotor pole 1330′, through stator pole 1321-A′, through stator 1305′, through stator pole 1322-A′, through rotor pole 1331′, through rotor 1310, through rotor pole 1331, through stator pole 1322-A, through stator 1305 and then back to stator pole 1321-A. The second flux path extends from stator pole 1323-B, through rotor pole 1532, through rotor 1310, through rotor pole 1332′, through stator pole 1323-B′, through stator 1305′, through stator pole 1324-B′, through rotor pole 1533′, through rotor 1310, through rotor pole 1533, through stator pole 1324-B, through stator 1305 and then back to stator pole 1323-B.

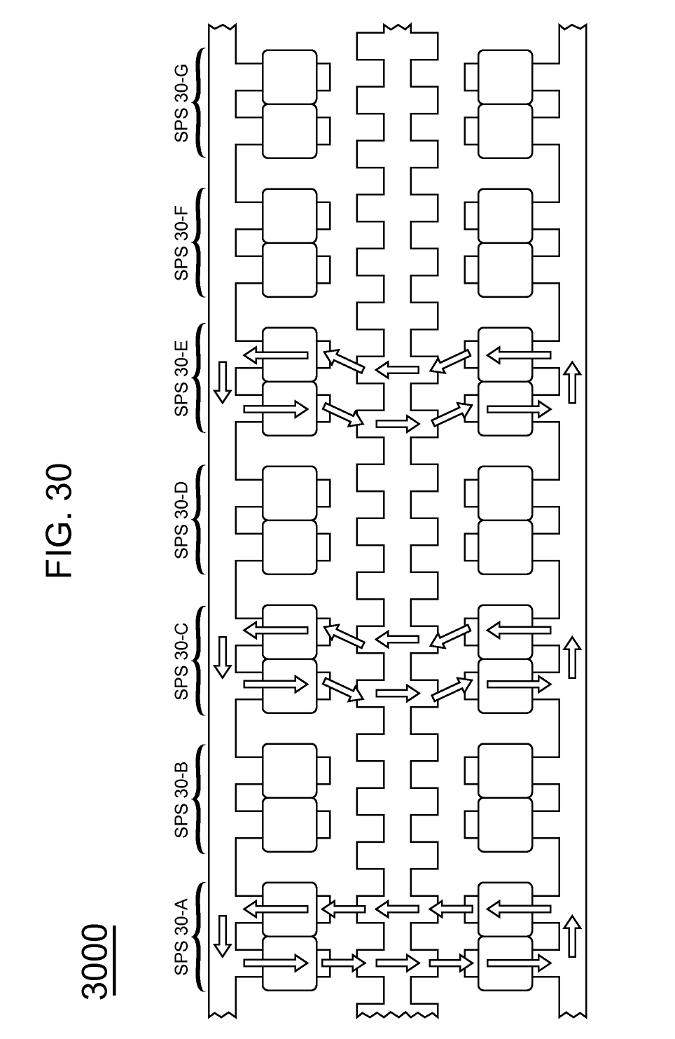

FIG. 30 shows yet another axial switched reluctance motor 3000 that is similar to motor 1600 of FIG. 16, except that motor 3000 includes two stators and exhibits 7 stator pole sets (SPSs) per phase group instead of 4 stator pole sets (SPSs) per phase group that motor 1600 employs. More particularly, motor 3000 includes stator pole sets (SPSs), namely SPS 30-A, SPS 30-B, SPS 30-C, SPS 30-D, SPS 30-E, SPS 30-F and SPS 30-G, as illustrated. Motor 2300 is thus a two stator/one rotor motor wherein the short flux paths indicated by arrows go through both stators and through the rotor. SPS 30-A, SPS 30-C and SPS 30-E are excited by a controller to generate respective flux paths designated by arrows adjacent SPS 30-A, SPS 30-C and SPS 30-E, as illustrated.

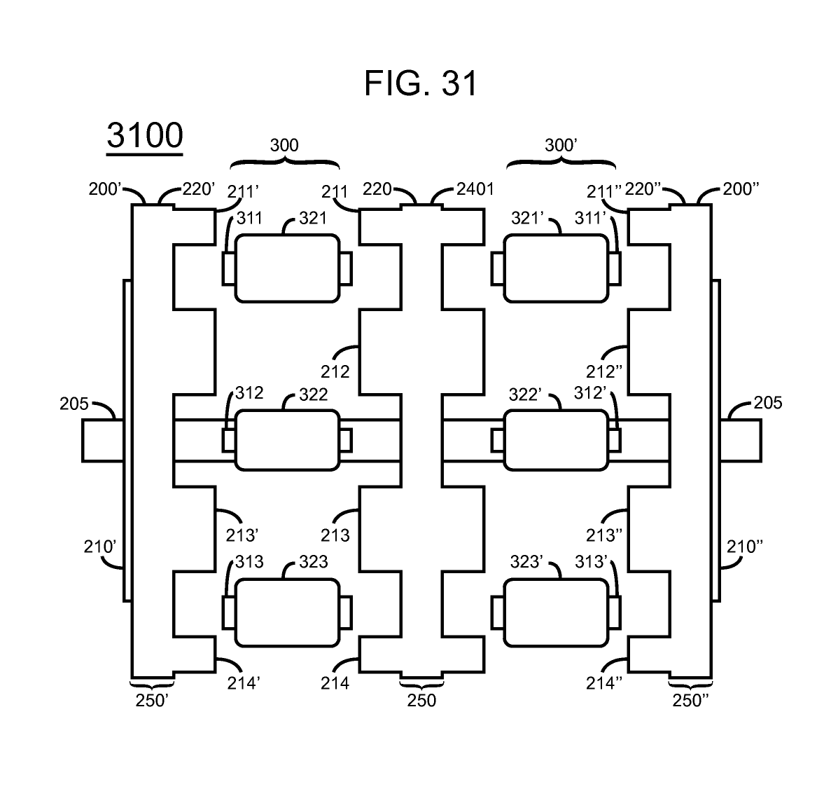

FIG. 31 shows another axial switched reluctance motor 3100 that is similar to two stator/one rotor motor 2400 of FIG. 24, except that motor 3100 includes two stators 300 and 300′, and three rotors 200, 200′ and 200″. Motor 2100 is thus a two stator/three rotor motor. Like numbers indicate like elements when comparing FIGS. 2A-2D, 3A-3B, 24 and 31.

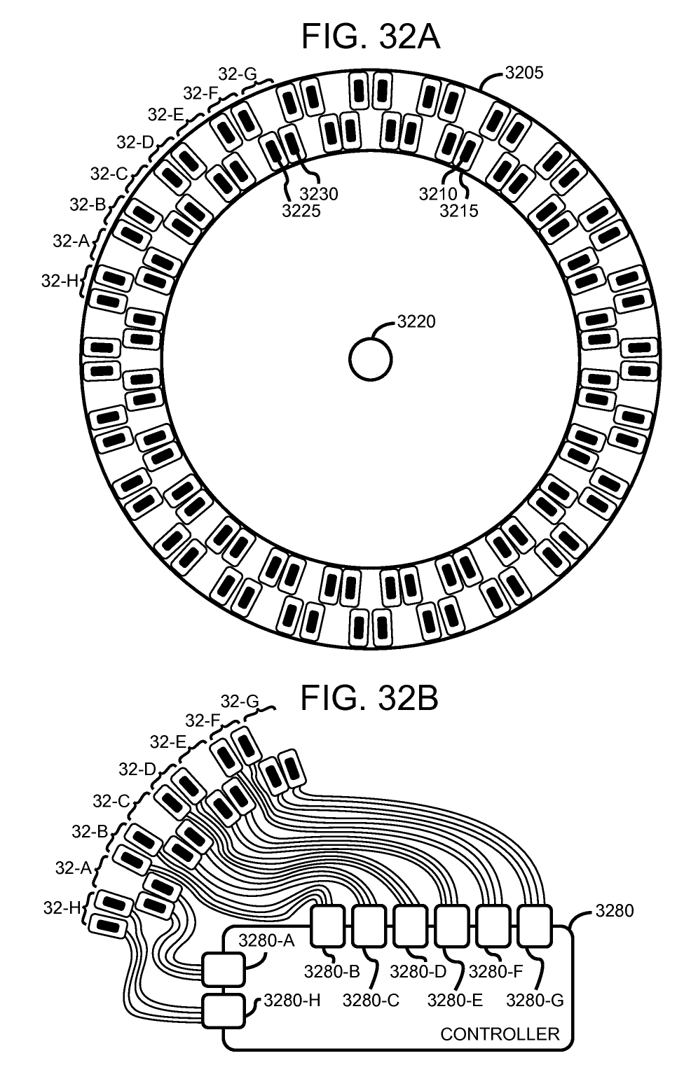

FIG. 32A is a face view of the disclosed stator 3205 that employs 96 stator poles, such as stator pole 3210, with respective coil windings 3215. Stator 3205 includes 6 phase groups that each include 8 staggered adjacent stator pole sets (SPSs). For example, one phase group may include SPSs 32-A, 32-B, 32-C, 32-D, 32-E, 32-F, 32-G and 32-H. Adjacent SPSs are staggered at different radii from axis 3220. For example, SPSs 32-A, 32-C, 32-E and 32-G exhibit a first radius with respect to axis 3220. In this case, SPSs 32-H, 32-B, 32-D and 32-F exhibit a second radius with respect to the axis 3220, wherein the second radius is larger than the first radius, as illustrated.

Within each phase group, adjacent stator poles that exhibit the same phase are “stator pole sets”. For example, in the phase group including SPSs 32-A, 32-B, 32-C, 32-D, 32-E, 32-F, 32-G and 32-H, stator pole 3225 and stator pole 3230 exhibit the same phase and are adjacent, and thus form a stator pole set 32-G. In this particular example, there are 8 phases in each phase group. In one embodiment, the stator pole pattern that the phase group including SPSs 32-A, 32-B, 32-C, 32-D, 32-E, 32-F, 32-G and 32-H repeats for other phase groups around the circumference of the entire stator 3205 although those phase groups are shown but not specifically labeled.

FIG. 32B shows a controller 3280 that includes 8 phase outputs 3280-A, 3280-B, 3280-C, 3280-D, 3280-E, 3280-F, 3280-G and 3280-H that generate respective phase commutation signals phase A, phase B, phase C, phase D, phase E, phase F, phase G and phase H for SPSs 32-A, 32-B, 32-C, 32-D, 32-E, 32-F, 32-G and 32-H, respectively. Controller 3280 generates these commutation signals phase A, phase B, phase C, phase D, phase E, phase F, phase G and phase H to activate respective stator poles. Poles of like phase may all be energized at the same time. While FIG. 32A only shows the SPSs 32-A, 32-B, 32-C, 32-D, 32-E, 32-F, 32-G and 32-H that form one phase group, the pattern of phase groups repeats all the way around the circumference of stator 3205 in one embodiment.

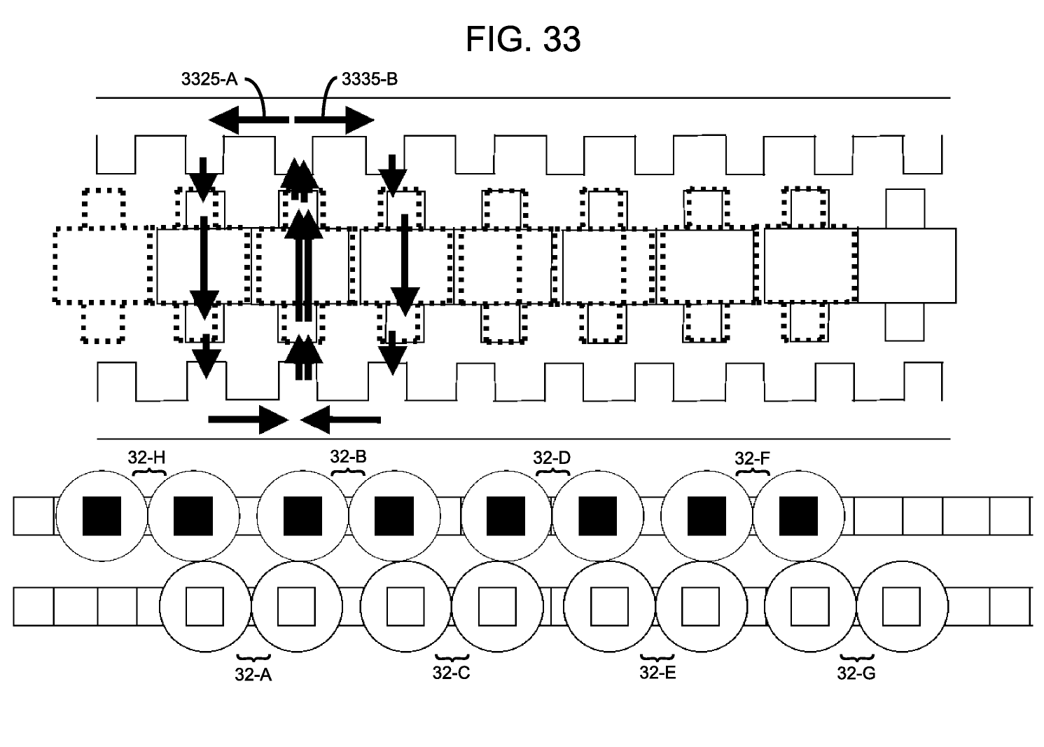

FIG. 33 shows SPSs 32-A, 32-B, 32-C, 32-D, 32-E, 32-F, 32-G and 32-H wherein SPS 32-A and 32-B are energized at the same time by controller 3280. SPSs 32-A, 32-C, 32-E and 32-G are situated at the first smaller radius of FIG. 32. SPSs 32-B, 32-D, 32-F and 32-H are situated at the second larger radius of FIG. 32. The flux path 3325-A associated with SPS 32-A travels in a counterclockwise direction. SPS 32-B is also energized and the resultant flux path 3335-B associated therewith is in the clockwise direction. In this embodiment with this stator and rotor configuration the rotor poles are in phase with one another.

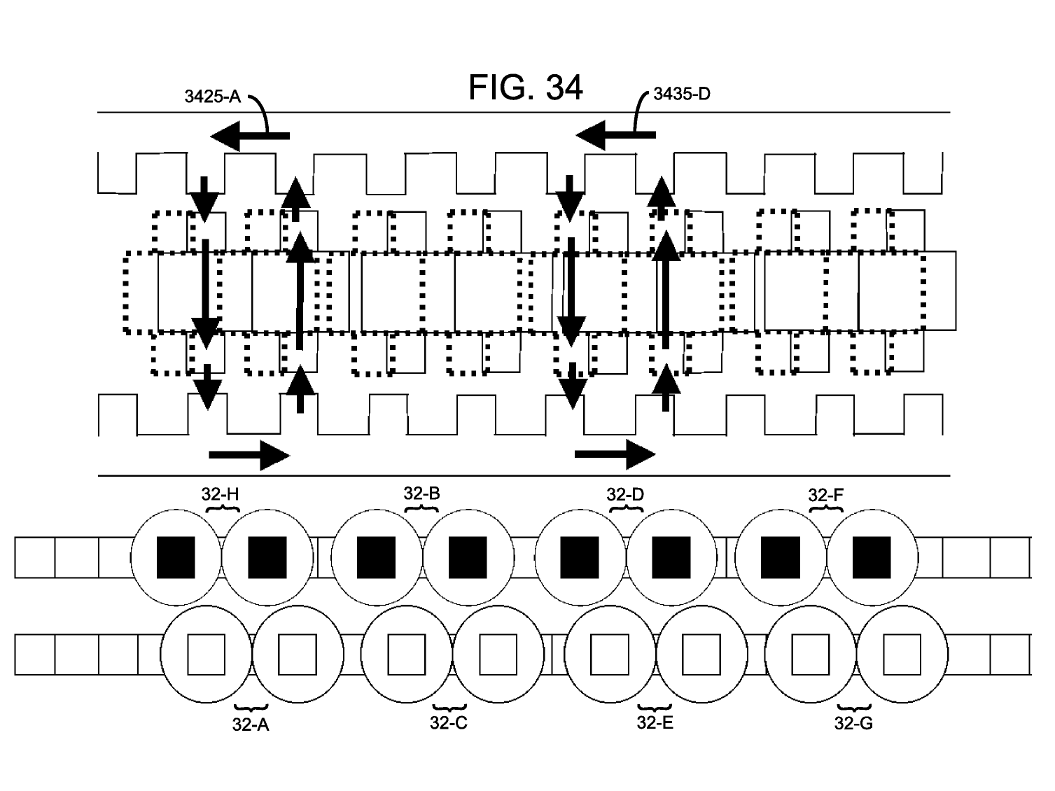

FIG. 34 shows SPSs 32-A, 32-B, 32-C, 32-D, 32-E, 32-F, 32-G and 32-H wherein SPSs 32-A and 32-D are energized at the same time by controller 3280. SPSs 32-A, 32-C, 32-E and 32-G are situated at the first smaller radius of FIG. 32. SPSs 32-B, 32-D, 32-F and 32-H are situated at the second larger radius of FIG. 32. The flux path 3425-A associated with SPS 32-A travels in a counterclockwise direction. SPS 32-D is also energized and the resultant flux path 3435-D associated therewith is in the counterclockwise direction. In this embodiment with this stator and rotor configuration the rotor poles are in phase with one another although the stator poles of the SPSs are staggered differently as illustrated.

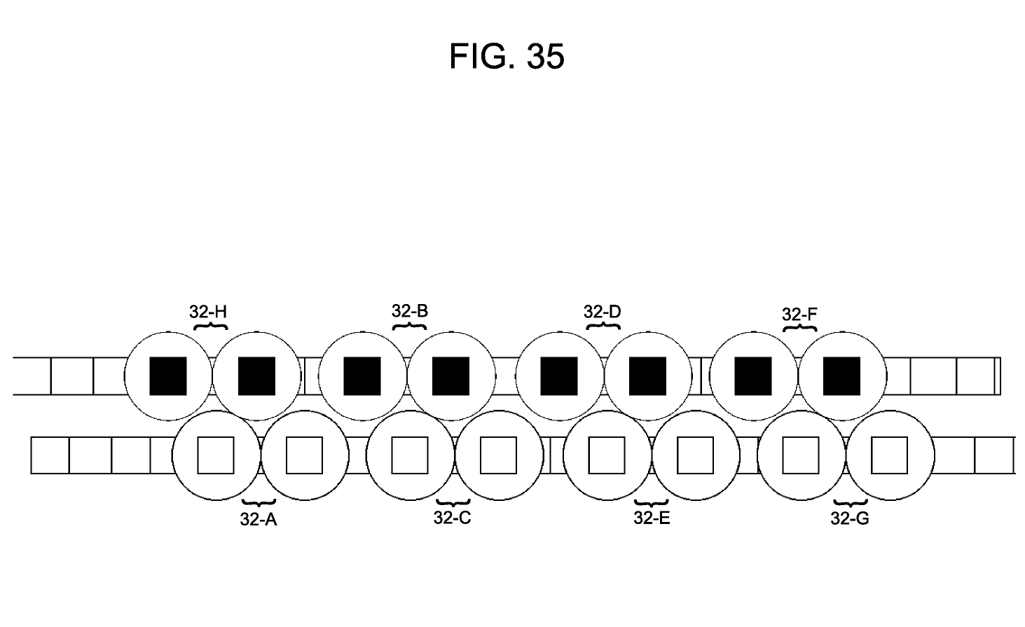

FIG. 35 shows SPSs 32-A, 32-B, 32-C, 32-D, 32-E, 32-F, 32-G and 32-H. SPSs 32-A, 32-C, 32-E and 32-G are situated at the first smaller radius of FIG. 32. SPSs 32-B, 32-D, 32-F and 32-H are situated at the second larger radius of FIG. 32. In this embodiment with this stator and rotor configuration the rotor poles are out of phase with one another and the stator poles of the SPSs are staggered different from FIGS. 33 and 34 as illustrated. In this configuration, the difference between the radiuses is desirably significantly reduced.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A switched reluctance motor, comprising:
a stator including a plurality of stator poles, the stator poles being situated in a first plane and oriented about a central axis,
a rotor configured to rotate about the central axis in a second plane axially spaced apart from the first plane; and
the stator including a plurality of stator pole sets, each stator pole set including multiple stator poles that are adjacent one another, each stator pole of a stator pole set exhibiting the same phase.

2. The switched reluctance motor of claim 1, wherein each stator pole set includes a pair of stator poles, the pair of stator poles of each stator pole set exhibiting the same phase which is different from the phase of other stator pole sets of the stator.

3. The switched reluctance motor of claim 1, wherein the stator includes a stator back iron assembly that is laminated.

4. The switched reluctance motor of claim 3, wherein the stator back iron assembly is coiled about the central axis.

5. The switched reluctance motor of claim 3, wherein the stator poles of the stator poles sets are laminated.

6. The switched reluctance motor of claim 1, wherein the rotor includes a rotor back iron assembly that is laminated.

7. The switched reluctance motor of claim 5, wherein the rotor back iron assembly is coiled about the central axis.

8. The switched reluctance motor of claim 5, wherein the rotor poles of the rotor are laminated.

9. The switched reluctance motor of claim 1, wherein each stator pole set exhibits a different phase than an adjacent stator pole set.

10. The switched reluctance motor of claim 1, wherein the stator includes multiple stator pole phase groups, each stator pole phase group including multiple stator pole sets, wherein each stator pole set of a stator pole phase group exhibits a different phase.

11. The switched reluctance motor of claim 1, wherein the stator pole sets of a particular stator pole phase group exhibit each of the phases of the switched reluctance motor.

12. The switched reluctance motor of claim 1, wherein the number of stator poles is greater than the number of rotor poles.

13. The switched reluctance motor of claim 1, wherein the number of rotor poles is greater than the number of stator poles.

14. The switched reluctance motor of claim 1, wherein stator poles are canted to receive respective stator coils.

15. The switched reluctance motor of claim 1, further comprising a controller coupled to the stator to provide commutating signals to the stator poles of the stator.

16. The switched reluctance motor of claim 1, wherein the rotor includes a plurality of rotor poles laminated on a flexible nonmagnetic substrate which exhibits first and second ends, the rotor poles exhibiting a size that changes along the flexible insulative substrate between the first and second ends of the flexible nonmagnetic substrate.

17. The switched reluctance motor of claim 1, wherein the stator includes a plurality of stator poles laminated on a flexible nonmagnetic substrate which exhibits first and second ends, the stator poles exhibiting a size that changes along the flexible insulative substrate from flexible nonmagnetic substrate.

18. The switched reluctance motor of claim 1, wherein the stator pole sets are staggered at two different radii from the axis.

19. The switched reluctance motor of claim 1, wherein the laminated rotor poles are integrated with the laminated rotor back iron.

20. The switched reluctance motor of claim 1, wherein the laminated stator poles are integrated with the laminated stator back iron.

21. The switched reluctance motor of claim 1, wherein each stator pole set is staggered radially with respect to an adjacent stator pole set.

22. A method, comprising:
providing a stator including a plurality of stator poles, the stator poles being situated in a first plane and oriented about a central axis;
providing a rotor configured to rotate about the central axis in a second plane axially spaced apart from the first plane; and
configuring the stator with a plurality of stator pole sets, each stator pole set including multiple stator poles that are adjacent one another, each stator pole of a stator pole set exhibiting the same phase.
